(19) United States
(12) Patent Application Publication
(10) Pub. No.: US 2013/0236870 A1
(43) Pub. Date: Sep. 12, 2013

(54) Online Interactive Practice System

(71) Applicants: Richard WASSERMAN, Curtice, OH (US); Richard LONGENECKER, Maplewood, NJ (US); Deborah MATTIN, Temperance, MI (US); Jamie CAROTHERS, Ida, MI (US); Lisa PROCYK, Bowling Green, OH (US); Sherry ANDREWS, Holland, OH (US)

(72) Inventors: Richard WASSERMAN, Curtice, OH (US); Richard LONGENECKER, Maplewood, NJ (US); Deborah MATTIN, Temperance, MI (US); Jamie CAROTHERS, Ida, MI (US); Lisa PROCYK, Bowling Green, OH (US); Sherry ANDREWS, Holland, OH (US)

(73) Assignee: PrepSim, LLC, Ottawa Lake, MI (US)

(21) Appl. No.: 13/416,564

(22) Filed: Mar. 9, 2012

(51) Int. Cl. G09B 23/28

(52) U.S. Cl. 434/262

(57) ABSTRACT

An online, interactive practice system is provided, which allows users to practice skills and to learn about desired subjects using interactive, multimedia practice modules (tools) relating to desired subjects. The system includes a computer system in communication with a plurality of remote user devices via a network, a plurality of multimedia practice modules stored in a database of the computer system each including a lesson relating to a healthcare-related topic and allowing a user to practice a skill relating to the lesson, and a common directory structure for aggregating each of the plurality of multimedia practice modules. The system transmits a software module corresponding to a selected multimedia practice module to at least one of the plurality of remote user devices, for execution thereby to generate a virtual practice environment where the user can view a lesson and virtually practice a skill relating to the lesson.

### BACKGROUND OF THE INVENTION

1. Field of the Invention

The present invention relates generally to electronic learning. More specifically, the present invention relates to an online, interactive practice system that allows students, practitioners, and other individuals to practice skills and to learn about desired subjects using interactive, multimedia practice modules (tools) relating to desired subjects

2. Related Art

Textbooks have long been a source of information for students, and a widely-used teaching tool for instructors. With the advent of digital technology, instructors are increasingly relying on computer-based instruction tools. One type of digital instruction tool is an electronic learning or “e-learning” system. E-learning systems exist in various forms, e.g., networked and/or standalone computer systems, computer-based collaborative learning systems, distance learning systems, technology-enhanced learning, etc.

Web-based e-learning systems are known, and various standards have been promulgated in connection with such systems. For example, the Shareable Content Object Reference Model (SCORM) is a known collection of standards and specifications relating to web-based e-learning. According to the SCORM standards, electronic lessons are distributed to local computing devices from one or more learning management system (LMS) servers in the form of Sharable Content Object (SCO) files. Data and content are exchanged between the LMS server(s) and the local devices at runtime, along with “manifest” information that instructs the local devices how to handle data and content transmitted from the LMS server(s).

In professions that require repetitive practice of skills, such as healthcare, medicine, automotive, and heating, ventilation and air conditioning (HVAC) disciplines, there is increasing interest in e-learning systems. However, existing e-learning systems in these fields suffer from a number of drawbacks. For example, existing e-learning systems often do not provide the user with a rich assortment of multimedia content in various forms, such as audio, video, manipulable models, etc. Moreover, existing e-learning systems are not suitable for allowing students to repeatedly practice skills learned during a lesson, since they do not provide an adequate virtual practice environment in which such skills can be exercised. Still further, existing e-learning systems do not adequately allow students to repetitively practice, assess, and remediate deficiencies, independently in a “self-help,” online environment. Accordingly, there is a need to address these and other shortcomings of existing web-based e-learning systems.

### SUMMARY OF THE INVENTION

The present invention relates to an online, interactive practice system. The system provides an online, virtual practice environment for allowing students, practitioners, and other individuals to practice skills and to learn about desired subjects using interactive, multimedia practice modules (tools) relating to desired subjects. The system includes a computer system in communication with a plurality of remote user devices via a network; a plurality of multimedia practice modules stored in a database of the computer system, each of the plurality of multimedia practice modules including a lesson relating to a healthcare-related topic and allowing a user to practice a skill relating to the lesson; and a common directory structure for aggregating each of the plurality of multimedia practice modules and allowing a user to select one of the plurality of multimedia practice modules, the common directory structure accessible using one or more of the plurality of remote user devices. In response to selection of one of the plurality of multimedia practice modules from the common directory structure, the computer systems transmits a software module corresponding to a selected multimedia practice module to at least one of the plurality of remote user devices, and the at least one of the plurality of remote user devices executes the transmitted software module to generate a virtual practice environment at the remote user device where the user can view a healthcare-related lesson and virtually practice a healthcare-related skill relating to the healthcare-related lesson.

In another embodiment, the present invention relates to an online, interactive practice system that includes a computer system in communication with a plurality of remote user devices via a network; a plurality of multimedia practice modules stored in a database of the computer system, each of the plurality of multimedia practice modules including a lesson relating to a professional or vocation-related topic and allowing a user to practice a skill relating to the lesson; and a common directory structure for aggregating each of the plurality of multimedia practice modules and allowing a user to select one of the plurality of multimedia practice modules, the common directory structure accessible using one or more of the plurality of remote user devices In response to selection of one of the plurality of multimedia practice modules from the common directory structure, the computer systems transmits a software module corresponding to a selected multimedia practice module to at least one of the plurality of remote user devices, and the at least one of the plurality of remote user devices executes the transmitted software module to generate a virtual practice environment at the remote user device where the user can view a professional or vocation-related lesson and virtually practice a skill relating to the profession or vocation-related lesson.

In another embodiment, the present invention relates to a method for online, interactive practice. The method includes the steps of providing a computer system in communication with a plurality of remote user devices via a network; storing a plurality of multimedia practice modules stored in a database of the computer system, each of the plurality of multimedia practice modules including a lesson relating to a healthcare-related topic and allowing a user to practice a skill relating to the lesson; aggregating each of the plurality of multimedia practice modules using a common directory structure; allowing a user to select one of the plurality of multimedia practice modules by accessing the directory structure using one or more of the plurality of remote user devices; transmitting a software module corresponding to a selected multimedia practice module to at least one of the plurality of remote user devices from the computer system; executing the transmitted software module to generate a virtual practice environment at the remote user device; presenting a healthcare-related lesson to the user using the virtual practice environment; and allowing a user to virtually practice a healthcare-related skill relating to the healthcare-related lesson, using the virtual practice environment.

In another embodiment, the present invention relates to a method for online, interactive practice. The method includes the steps of providing a computer system in communication with a plurality of remote user devices via a network; storing a plurality of multimedia practice modules stored in a database of the computer system, each of the plurality of multimedia practice modules including a lesson relating to a professional or vocation-related topic and allowing a user to practice a skill relating to the lesson; aggregating each of the plurality of multimedia practice modules using a common directory structure; allowing a user to select one of the plurality of multimedia practice modules by accessing the directory structure using one or more of the plurality of remote user devices; transmitting a software module corresponding to a selected multimedia practice module to at least one of the plurality of remote user devices from the computer system; executing the transmitted software module to generate a virtual practice environment at the remote user device; presenting a healthcare-related lesson to the user using the virtual practice environment; and allowing a user to virtually practice a professional or vocation-related skill relating to the lesson, using the virtual practice environment.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating hardware and software components of the system of the present invention;

FIG. 2A is a diagram illustrating the common practice tool directory structure of the present invention in greater detail;

FIG. 2B is a diagram illustrating a matrix of possible practice modules capable of being generated by the present invention;

FIGS. 3A-3B are flowcharts showing processing steps carried out by the system;

FIG. 4 is a screenshot showing a main screen generated by the system;

FIGS. 5-7 are screenshots showing instructor, institution, and student login screens, respectively, generated by the system;

FIG. 8 is a screenshot showing a main course summary screen generated by the system;

FIG. 9 is a screenshot showing an initial screen generated by the system relating to an example of a vocation-related lesson and skill practice course, e.g., a cardiac assessment and bedside cardiac practice course;

FIGS. 10-13 are screenshots showing a cardiac assessment and bedside cardiac practice module in detail;

FIG. 14 is a screenshot showing an initial screen generated by the system relating to another example of a vocation-related lesson and skill practice course, e.g., a respiratory assessment practice course;

FIGS. 15-20 are screenshots showing a respiratory assessment practice module in detail;

FIG. 21 is a screenshot showing a catalog screen generated by the system relating to a patient assessment practice tool catalog;

FIG. 22 is a screenshot showing a product overview screen generated by the system relating to a cardiac and respiratory practice module;

FIG. 23 is a screenshot showing a screen generated by the system for allowing an instructor to request a free trial of a desired practice module;

FIG. 24 is a screenshot showing a module overview screen generated by the system relating to a cardiac and bedside monitoring module;

FIGS. 25-31 are screenshots showing various screens generated by the system for allowing a user to purchase one or more practice modules; and

FIGS. 32-33 are screenshots illustrating a “dashboard” generated by the system for allowing an instructor or an institutional user to monitor/control account settings and parameters and to perform other functions.

### DETAILED DESCRIPTION OF THE INVENTION

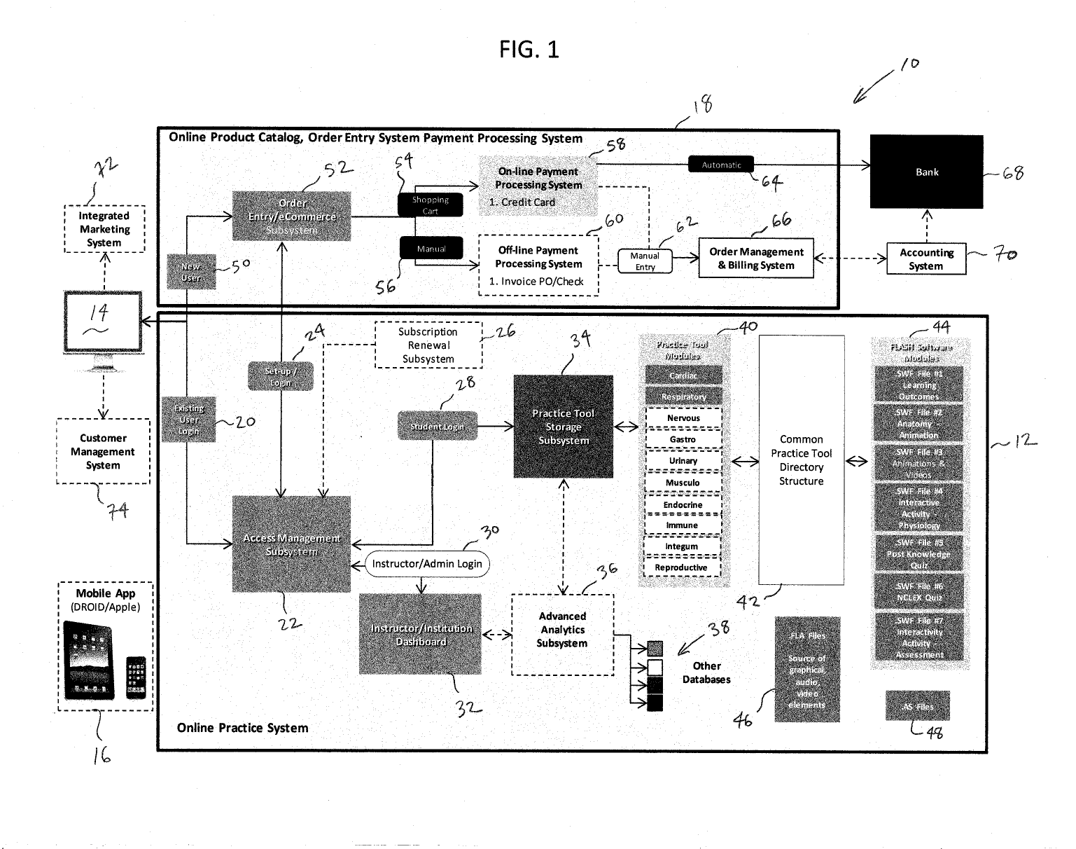

The present invention relates to an online interactive practice system, as discussed in detail below in connection with FIGS. 1-31. It is noted that the terms “tool” and “module” are used herein interchangeably.

FIG. 1 is a diagram illustrating hardware and software components of the system 10 of the present invention. The system 10 provides an online, virtual practice environment for allowing students, practitioners, and other individuals to practice skills and to learn about vocation-related subjects using interactive, multimedia practice modules (tools) relating to desired subjects. Importantly, the system 10 provides a single platform that can be accessed by a variety of users, and which aggregates and delivers interactive lessons and practice modules to such users in various multimedia formats (including, but not limited to, audio, video, text, etc.).

The system 10 includes an online practice system 12 that is accessible over a network (e.g., the Internet, a local area network (LAN), a wide area network (WAN), a cellular data network, etc.) by students, instructors, and/or administrators using remote computing devices, such as a stand-alone computer system (personal computer) 14 and/or one or more mobile computing devices 16 (including, but not limited to, cellular telephones, smart phones (e.g., DROID and/or APPLE IPHONE smart phones, etc.), tablet computers (e.g., APPLE IPAD computers, etc.), laptop computers, etc.). The practice system 12 aggregates practice modules/tools of various multimedia formats, and delivers such modules to the remote computer system 14 and/or mobile computing devices 16. The practice modules/tools could be delivered by the system 12 could comply with one or more electronic learning standards such as Sharable Content Object Reference Model (SCORM) or other applicable standards. The practice system 12 could be hosted by suitable computer hardware such as one or more computer servers (e.g., single-processor or multiple-processor servers having INTEL or other suitable microprocessors) running a suitable operating system (e.g., WINDOWS SERVER, UNIX, Linux, MacOS, etc.). The functionality provided by the practice system 12 could be coded in any suitable high- or low-level computer programming languages, including, but not limited to, hypertext markup language (HTML), extensible markup language (XML), Java, C, C++, C#, ADOBE FLASH, Moodle, scripting languages, etc. Although the Moodle system is listed as an example of a learning management system (LMS) that could be used to support the present invention, any other type of LMS could be used without departing from the spirit and scope of the present invention. Further, it is noted that associated communications equipment for providing network (e.g., Internet) connectivity to the practice system 12 could be provided, including routers, firewalls, etc.

The system 10 also includes an online product catalog, order entry, and order processing system 18 in communication with the practice system 12. The system 18 provides information to uses about practice modules that area available for purchase, handles orders relating to such modules, and processes payments relating to such orders. The system 18 is thus an “e-commerce” platform that communicates with the practice system 12 and handles online payments for desired practice modules that are available from the practice system 12. The system 18 could be hosted by the same type of computer hardware listed above in connection with the practice system 12, as well as associated operating system software, and the functionality provided by the system 18 could be coded using any of the programming languages listed above in connection with the practice system 12. Moreover, it is noted that the systems 12 and 18 need not be separate computer systems, but rather, a single computer system could be provided which performs the functions of both systems 12 and 18.

The practice system 12 includes a number of software modules and processes which operate together to provide the functionality disclosed herein. For example, as shown in block 20, an existing user login process 20 is provided, and handles login/authentication of existing users, including, but not limited to, students, instructors, institutions, and administrators. Authentication and tracking of user accounts, as well as the login process, is handled by an access management subsystem 22. The access management subsystem 22 also communicates with the system 18 to obtain information relating to product catalogs, as well as to coordinate billing and payment issues relating to user accounts and various practice modules/tools purchased by the user, as illustrated by setup/login block 24. Optionally, the access management subsystem 22 could communicate with a subscription renewal subsystem 26 which handles existing subscriptions by users to practice modules provided by the system 12, as well as requests for new subscriptions.

As shown by blocks 28 and 30, the access management subsystem can provide different functionality depending on whether the user is a student (block 28) or an instructor, administrator, or institution (block 30). If the user is an instructor, administrator, or institution, a “dashboard” 32 is generated and displayed by the system 12 to the user, which allows the user to perform various administrative functions such as configure existing student accounts, configure/modify existing practice modules/lessons, upload new practice modules/lessons, and perform other functions. If the user is a student (block 28), access is provided to a practice tool storage subsystem 34 which controls access to a plurality of practice tools/modules 40. The practice tools/modules could relate to various educational and/or professional subjects, including, but not limited to, medicine, law, vocational training, technical subjects, technical training, etc. For example, as shown in FIG. 1, the modules 40 could relate to various medical subjects such as various systems of the human body (e.g., cardiac, respiratory, nervous system, gastrointestinal systems, urinary systems, musculoskeletal systems, endocrine, immune systems, integum, and reproductive systems). Importantly, as will be discussed in greater detail below, the modules 40 not only teach the student various topics relating to such subjects using interactive, multimedia lessons, they also allow the student to practice vocation-related skills in an easy-to-use, virtual practice environment. The system 12 thus provides online, “on-demand,” virtual practice services to students so that such students can practice medical skills whenever they want, whenever they want, using the students' local computer systems 14, 16 in communication with the system 12.

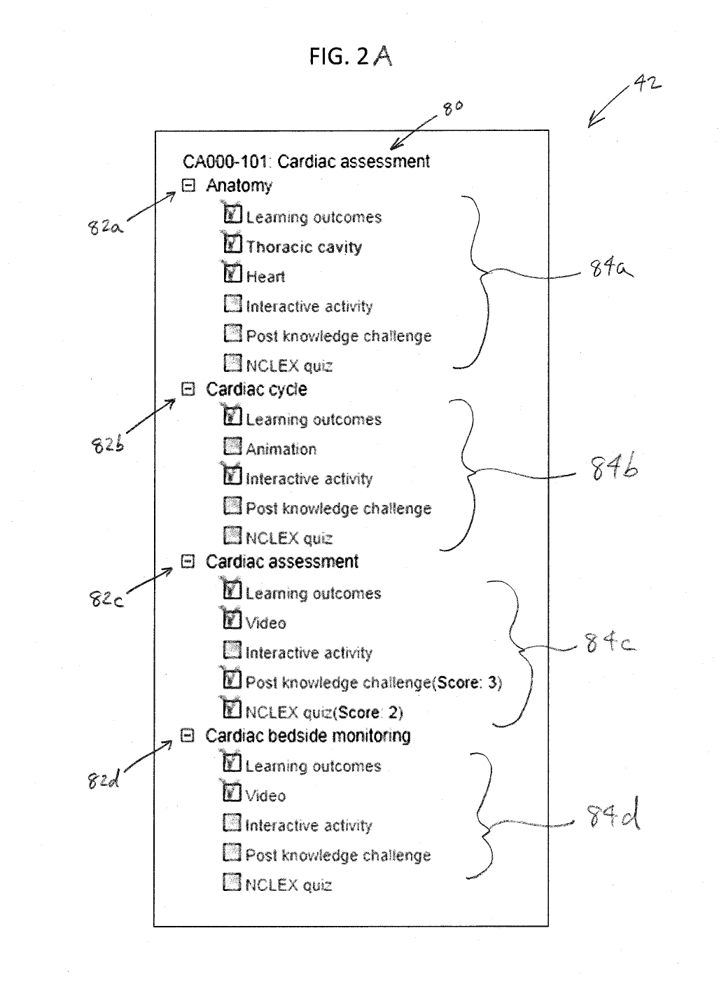

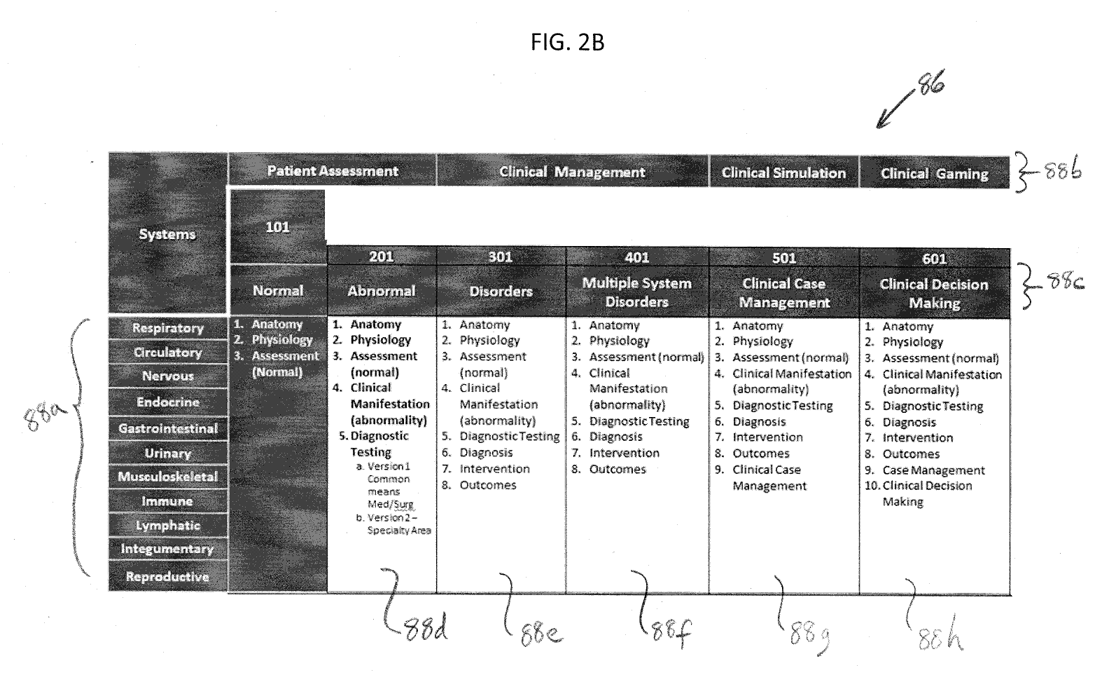

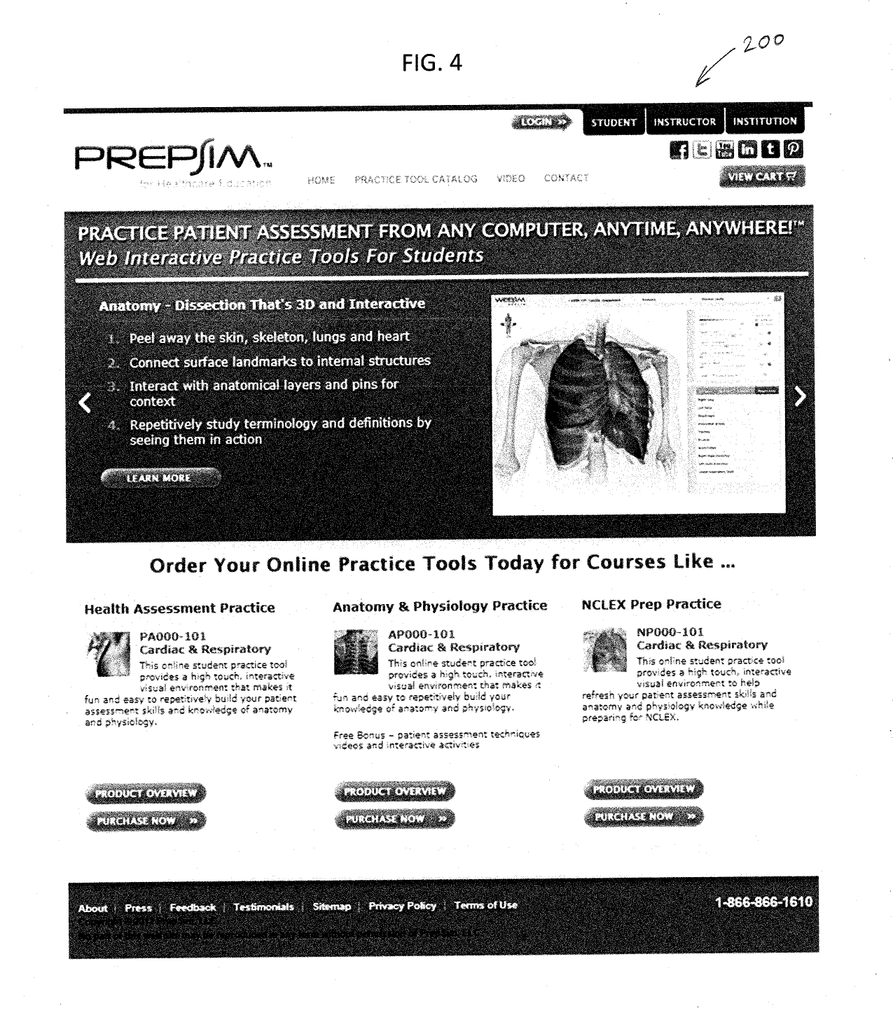

The system 12 also provides a “common” practice tool directory structure 42 which allows students to quickly and conveniently access and utilize desired practice modules/lessons. Importantly, the directory structure 42 (discussed in greater detail below in connection with FIG. 2) serves to aggregate practice modules/lessons of various types (e.g., audio, video, text, interactive models, etc.) and of various subjects, thereby providing a single point of access for the student to a broad array of subject matter. The directory structure 42 also coordinates access to, and delivery of, a plurality of software modules 44 which correspond to one or more of the practice modules 40. The software modules could be programmed in ADOBE FLASH or in any other suitable software, and provide a common set of practice tool features that can be used with each of the subjects provided by the modules 40. The software modules 40, 44 could provide practice tool functionality in connection with various subjects. For example, in the healthcare field, the modules 40, 44 could include topics such as learning outcomes, anatomy, physiology, clinical manifestations, diagnostic testing, diagnosis, intervention, outcomes, clinical case management, and clinical decision making lessons and skills for each system of the body. Each lesson and skill can include applicable lessons and quizzes, certification/licensing exams, sample quizzes, etc. (e.g., NCLEX and national registry exams, etc.). The modules 44 thus provide a “core” set of practice tool functionality that can be applied to each of the subjects offered by the practice tool modules 40. Additionally, one or more animation (.FLA) files 46 could be provided by the system 12 in connection with various lessons/practice tools, as well as other types of files such as .AS files 48. In response to selection of one of the practice tools 40 using the common directory structure 42, the system 12 transmits one or more of the software modules 44 and/or the files 46, 48 to the user's local device (e.g., to the computer system 14 and/or to the mobile communication device 16), for execution by the local device to generate a virtual practice environment for the user. Examples of the practice tools/modules that are provided by the system 12 are discussed in greater detail below in connection with FIGS. 4-31.

It is noted that the system 12 could also include an optional, advanced analytics subsystem 36, which provides useful statistical information to instructors, administrators, etc. The subsystem 36 could store/obtain such information from databases 38. Analytics/statistics that could be provided include, but are not limited to, course attendance, types practice modules/tools most frequently accessed by students, etc. Such functionality allows instructors/administrators to readily adapt or modify course subject matter in response to student actions monitored by the subsystem 36, thus providing a powerful feedback mechanism to instructors and administrators.

The system 18 also includes a plurality of a number of software modules and processes which operate together to provide the functionality disclosed herein. For example, as shown by block 50, if the user is a new user, access is provided to an order entry/e-commerce subsystem 52 that allows the user to create an account with the system 10 and to purchase one or more desired practice modules/tools offered by the system 18. Selection of desired practice modules/tools could be by way of a virtual shopping cart 54, or by way of specific (“manual”) selections of desired practice modules/tools, illustrated by block 56. Payment for selected practice modules/tools could be handled in many ways. For example, if immediate payment is desired (e.g., by way of a credit card), such payment could be handled by an online payment processing subsystem 58. Alternatively, an invoice or purchase order could be issued by an offline payment processing subsystem 60, which is capable of processing payment by other methods, such as by check, money order, etc. Manual and/or automatic payment handling processes 62 and 64 coordinate processing with the subsystems 58, 60, and an order management and billing system 66 is provided for coordinating all billing and payment activities. Payments received by the system 18 could be transmitted to a bank 68, and optionally, the system 18 could communicate with an external accounting system 70 that provides desired accounting functions.

FIG. 2A is a diagram illustrating the common practice tool directory structure 42 of the present invention in greater detail. The common directory structure 42 provides a convenient, easy-to-use interface that aggregates practice modules/lessons of various subjects and of various different multimedia types, and which allows students to quickly and conveniently navigate and access such modules/lessons. As can be seen, the directory structure 42 is organized in the form of an expandable and collapsible tree structure, wherein the root 80 of the tree describes the overall subject matter category (e.g., cardiac assessment), and the leaves 82a-82d of the tree describe various sub-topics that are available relating to the subject matter category 80. Thus, for example, the student can access a wide array of sub-topics relating to cardiac anatomy, cardiac cycle, cardiac assessment, cardiac bedside monitoring, etc. Within the sub-topics 82a-82d are additional leaves 84a-84d which list the various practice modules that are available for the sub-topics. Thus, as shown in FIG. 2, for the anatomy sub-topic 82a, six practice modules 84a are available to the student: leaning outcomes, thoracic cavity, heart, interactive activities, post-knowledge challenges (e.g., quizzes, tests), as well as a certification (NCLEX) quiz. The practice modules 84a-84d could be of various types, e.g., they could be text-based, audiovisual, etc., and they could each include different types of features such as animation, rotatable/manipulable models of the human body, etc. As can be appreciated, the directory structure 42 thus provides a single, convenient mechanism for aggregating practice tools and associated content, thereby obviating the need for a student to have to search for desired practice modules and/or content. Moreover, it is noted that the directory structure 42 could be expanded as desired, e.g., it could have more than one root 80 so that other subject matter categories and associated sub-topics and practice modules could be accessed. Of course, the number and types of practice modules listed in the directory structure 42 could be varied as desired without departing from the spirit or scope of the present invention. Indeed, as will be discussed in greater detail in connection with FIG. 2B below, the common directory structure 42 could list multiple modules covering different subject areas, as well as multiple sub-modules.

FIG. 2B is a diagram illustrating a matrix 86 of possible practice modules provided by the present invention. As can be seen, practice modules could be provided in connection with a variety of systems of the body 88a, such as respiratory, circulatory, nervous, endocrine, gastrointestinal, urinary, musculoskeletal, immune, lymphatic, integumentary, and reproductice systems. Further, the modules could be directed to specific skill categories 88b, such as patient assessment, clinical management, clinical simulation, and clinical gaming. Moreover, the practice modules could be tailored to specific skill sub-sets 88c, such as normal or abnormal patient assessment, disorders, multiple system disorders, clinical case management, and clinical decision making. Various combinations of modules could be provided depending upon the combination of systems and skills discussed above, and as illustrated by the practice modules 88d-88h. Such modules could include, but are not limited to, anatomy modules, physiology modules, patient assessment modules, clinical manifestation modules, diagnostic testing modules, diagnosis modules, intervention modules, outcomes modules, case management modules, and clinical decision-making modules. Moreover, each of these modules could include sub-modules such as a learning outcomes sub-module, an animation sub-module, an interactive activity, a quiz, a test, or a certification or licensing examination. Depending upon the contents of each module, the directory structure 42 discussed above could be dynamically updated, and it could also be expanded to provide access to more than one module and all associated sub-modules.

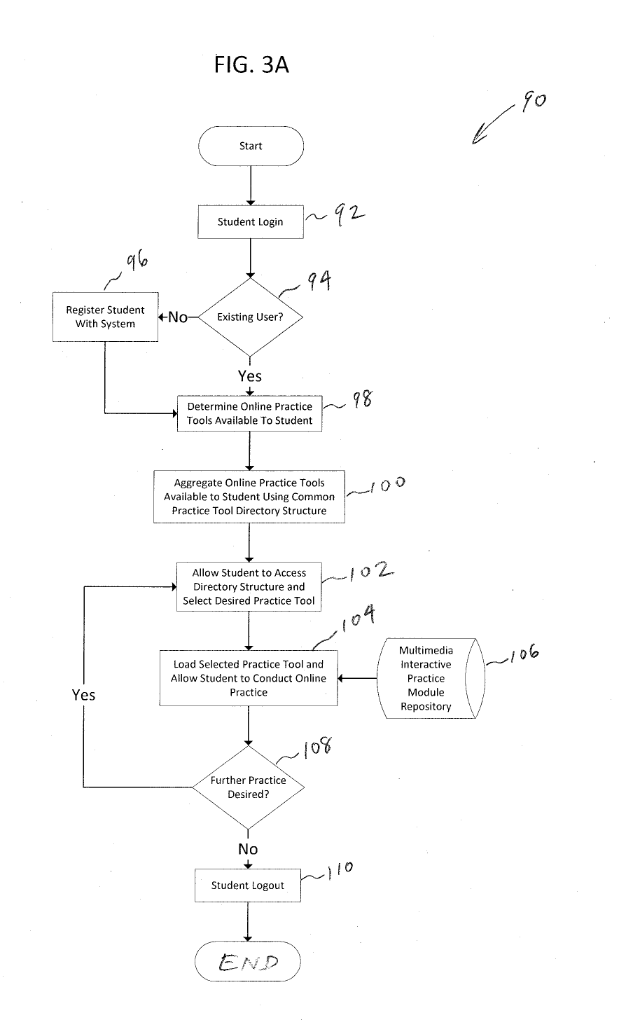

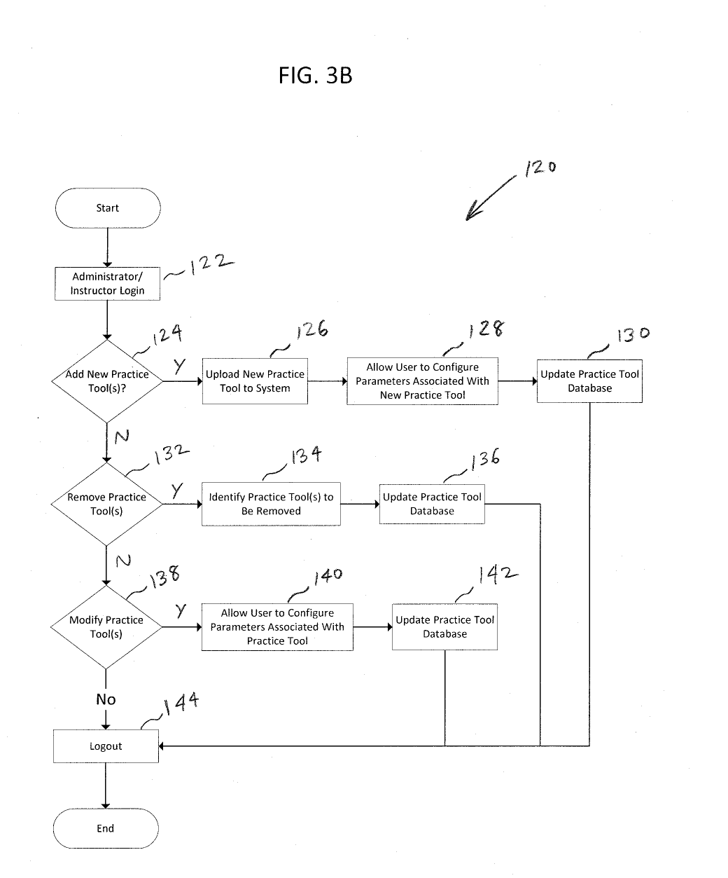

FIGS. 3A-3B are flowcharts showing processing steps carried out by the system. Referring to FIG. 3A, there is shown a flowchart 90 illustrating processing steps carried out by the present invention for providing online practice tools/modules to students. Beginning in step 92, the system presents the student with a login screen. In step 94, a determination is made as to whether the student is an existing user, e.g., whether the student has already registered with the system and has a valid account and password. If a negative determination is made, step 96 occurs, wherein the student is registered with the system. This could be accomplished by the system 18 of FIG. 1, which generates a series of screens for allowing the student to create and configure a user account. Once the account has been created, or if a positive determination is made in step 94 (i.e., the student is an existing user), step 98 occurs, wherein the system determines practice tools/modules that are available to the student. This information could be stored in a file in the system that is associated with a course and/or the student, and which one or more practice tools/modules that are available to the student. In step 100, once the available practice tools/modules have been determined, the common practice tool directory structure 42 shown in FIGS. 1-2 is configured to list all of the practice tools/modules that are available to the student. In this manner, the system aggregates the practice tools/modules into a single directory structure that is easy for the student to access and navigate, and which “culls together” various practice tools/modules of different types and/or subjects.

In step 102, the student is allowed to access the directory structure 42 and to select a desired practice tool/module from the directory structure 42. In step 104, the selected practice tool/module is loaded, and the student is allowed to use the module. As will be discussed in greater detail below in connection with FIGS. 4-31, the modules can be accessed in a convenient, web-based user interface accessible by the student using a conventional web browser executing on the student's local computer system and/or mobile device (e.g., the devices 14 and 16 shown in FIG. 1). Moreover, the module can be accessed by way of a software application (“app”) executing on the student's mobile communication device, such as a smart phone (e.g., ANDROID, IPHONE, etc.). By way of non-limiting example, the selected practice tool/module could be loaded from a multimedia interactive practice repository (database) 106, and delivered to the student's local computer and/or mobile communications device as course files and/or content files that are executed locally by the student's device. There could also be server-side components (executing, for example, on the system 12) which communicate with the student's local computer and/or communications device.

In step 108, a determination is made as to whether the student desires to continue practicing/learning using the system. If so, control returns to step 102 so that the student can select a new practice tool/module. Otherwise, step 110 occurs, wherein the student logs out of the system.

Referring to FIG. 3B, a flowchart 120 is shown illustrating processing steps carried out by the system for allowing an administrator, instructor, and/or institutional user to perform administrative functions using the system. In step 122, the administrator, instructor, and/or institutional user logs into the system. In step 124, a determination is made as to whether the user desires to add a new practice tool/module to the system. If so, steps 126-130 occur, wherein in step 126 the user uploads a new practice tool/module to the system. Then, in step 128 the system permits the user to configure one or more parameters associated with the new practice tool/module, including, but not limited to, identification of student(s) allowed to access the new practice tool/module, content and attributes associated with the practice tool/module (e.g., whether the module includes quizzes, tests, three-dimensional models, etc.), and other information. In step 130, the practice tool database 106 of FIG. 3A is updated with the new practice tool/module and associated parameters.

In step 132, a determination is made as to whether the user desires to remove an existing practice tool/module from the system. If so, steps 134 and 136 occur, wherein in step 134, the user identifies a practice tool/module to be removed, and in step 136, the practice tool database 106 of FIG. 3A is update by removing the practice tool/module.

In step 138, a determination is made as to whether the user desires to modify an existing practice tool. If so, steps 140-142 occur. In step 140, the user can alter one or more parameters/attributes (such as those listed above in connection with step 128) of one or more practice tools. Then, in step 142, the practice tool database 106 of FIG. 3A is updated to reflect the updated parameters/attributes. Finally, in step 144, the user is logged out of the system.

The various features of the practice tools/modules offered by the system of the present invention will now be discussed in detail in connection with FIGS. 4-31. It is noted that, although the examples discussed in FIGS. 4-31 relate to healthcare/medical practice tools/modules, numerous other types of practice tools/modules could be provided by the system of the present invention. Indeed, the system could provide an online practice environment not only in the healthcare/medical field, but also in other fields such as engineering, law, science, vocational training (e.g., heating, ventilation, and air conditioning (HVAC) system maintenance training/practice, plumbing, electrical systems, etc.), any other desired disciplines/fields. For HVAC, automotive, and other professions that require critical thinking and practice to perfect skills, the system also enables instructors and institutions to monitor students' practice habits, learning progress, and results. Also, it is noted that the discussion below in connection with FIGS. 4-31 is provided in connection with “screens” generated by the system. Such screens could be rendered as web pages displayed on the user's local computer system and/or mobile device. They could also be rendered by a standalone, software “app” that executes on the user's local computer system and/or mobile device and which communicates with the system 10 of FIG. 1.

FIG. 4 is a screenshot showing a main screen 200 generated by the system. As can be seen, the screen 200 provides general information about the system 10, as well as brief summaries of some of the practice tools provided by the system 10. For example, as shown, the summaries could be directed to practice tools for health assessment practice, anatomy and physiology practice, and certification/licensing examination preparation and practice (e.g., NCLEX examinations for nursing, national registry for paramedics, etc.). The screen 200 allows the user to not only obtain information about such practice tools, but to also purchase one or more desired practice tools.

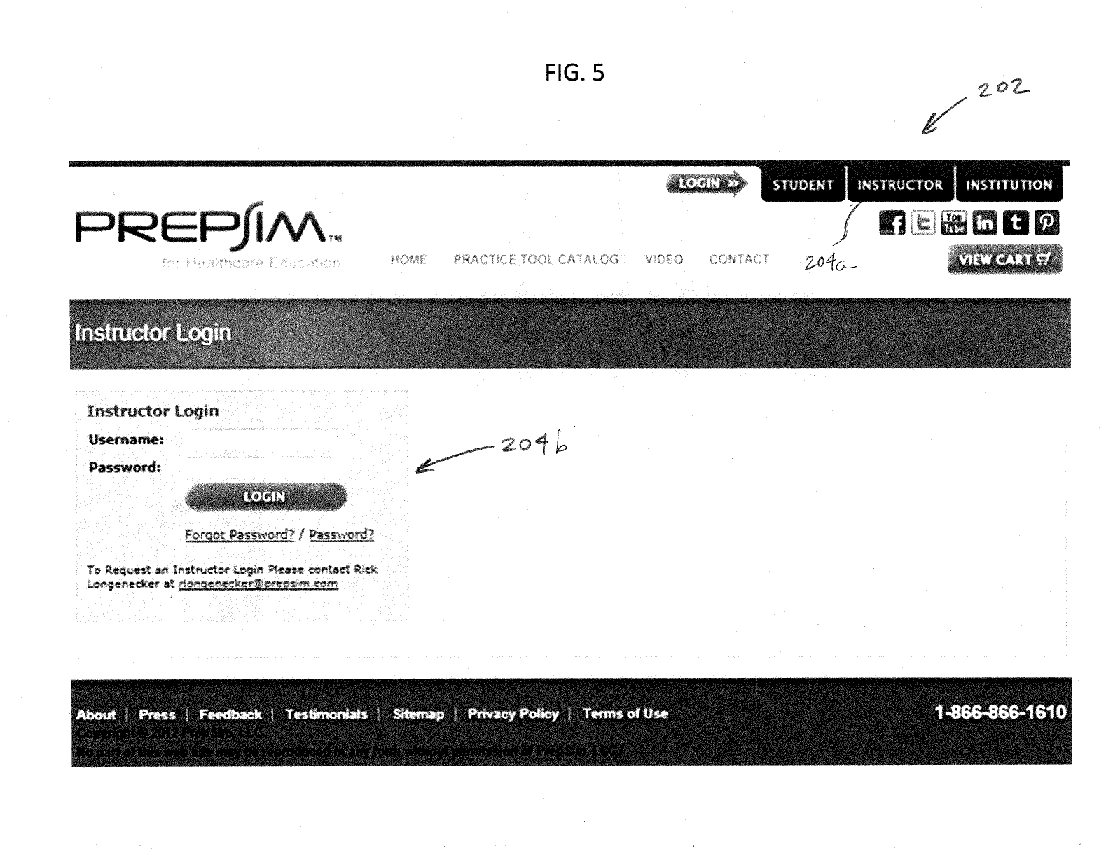

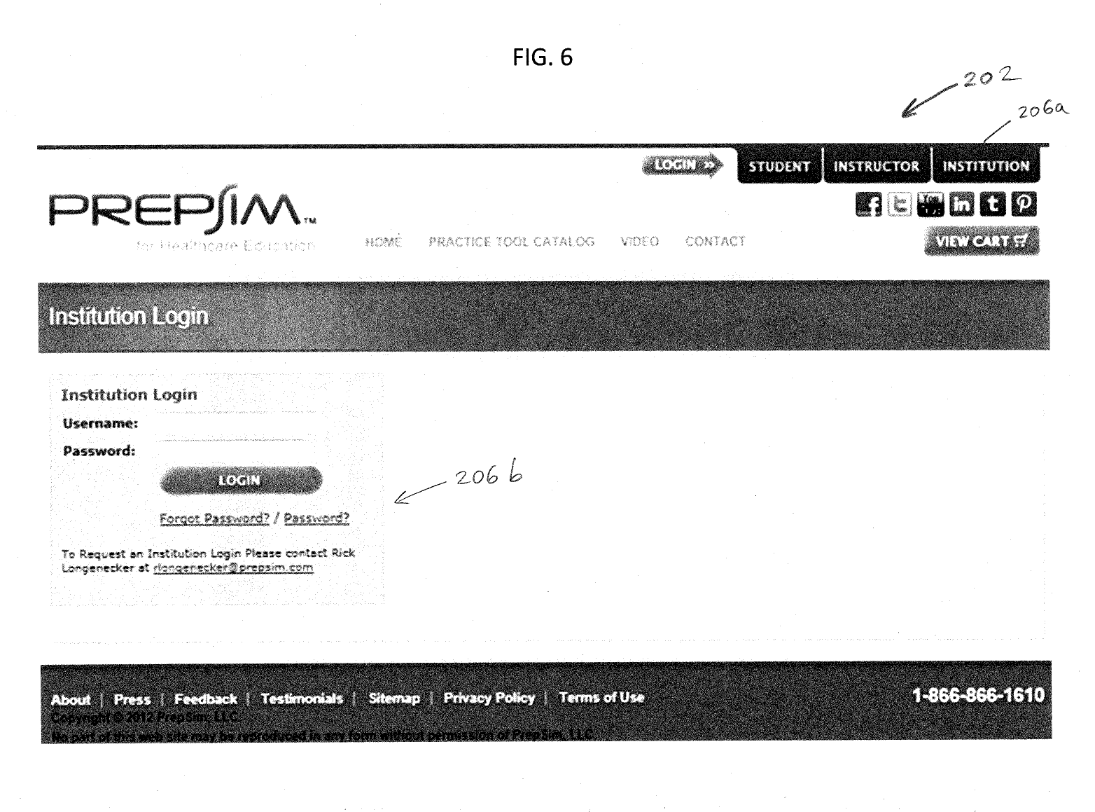

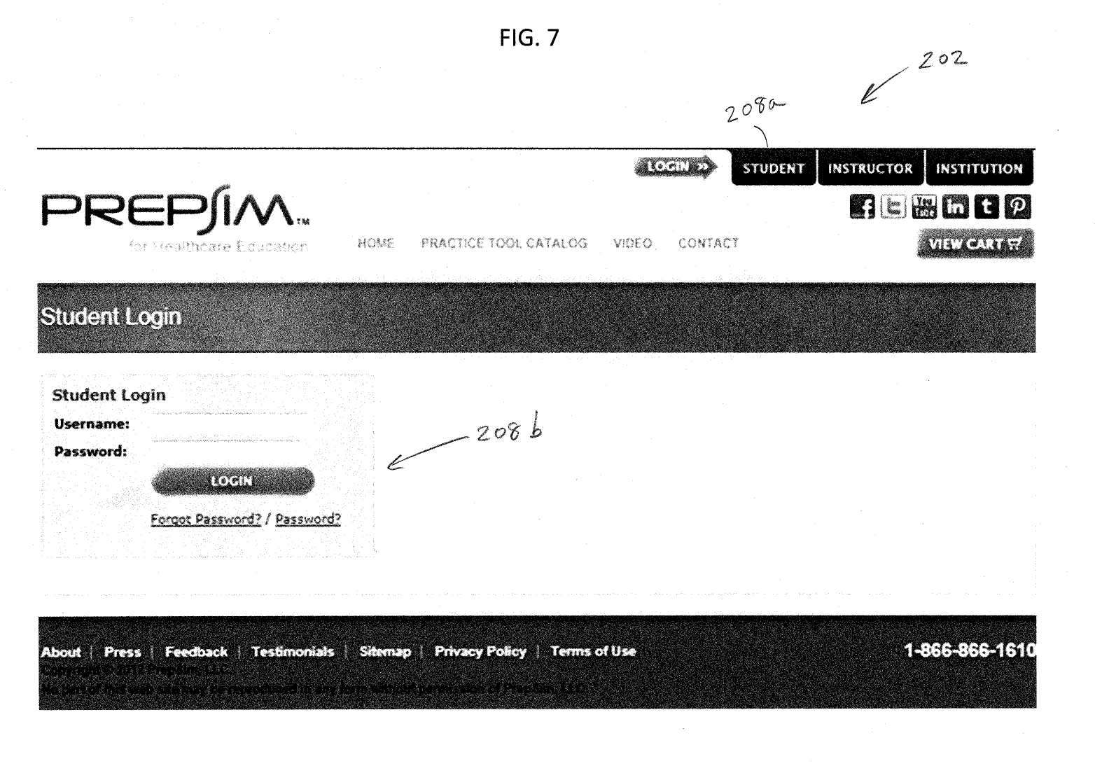

FIGS. 5-7 are screenshots showing instructor, institution, and student login screens, respectively, generated by the system. As shown in FIG. 5, a screen 202 is generated by the system which allows an instructor and/or administrator to log into the system by clicking on an “Instructor” tab 204a and providing login credentials using login interface 204b. Similarly, as shown in FIG. 6, the screen 202 allows an institutional user to log into the system by clicking on an “Institution” tab 206a and providing login credentials using login interface 206b. Also, as shown in FIG. 7, the screen 202 allows a student to log into the system by clicking on a “Student” tab 208a and providing login credentials using login interface 208a.

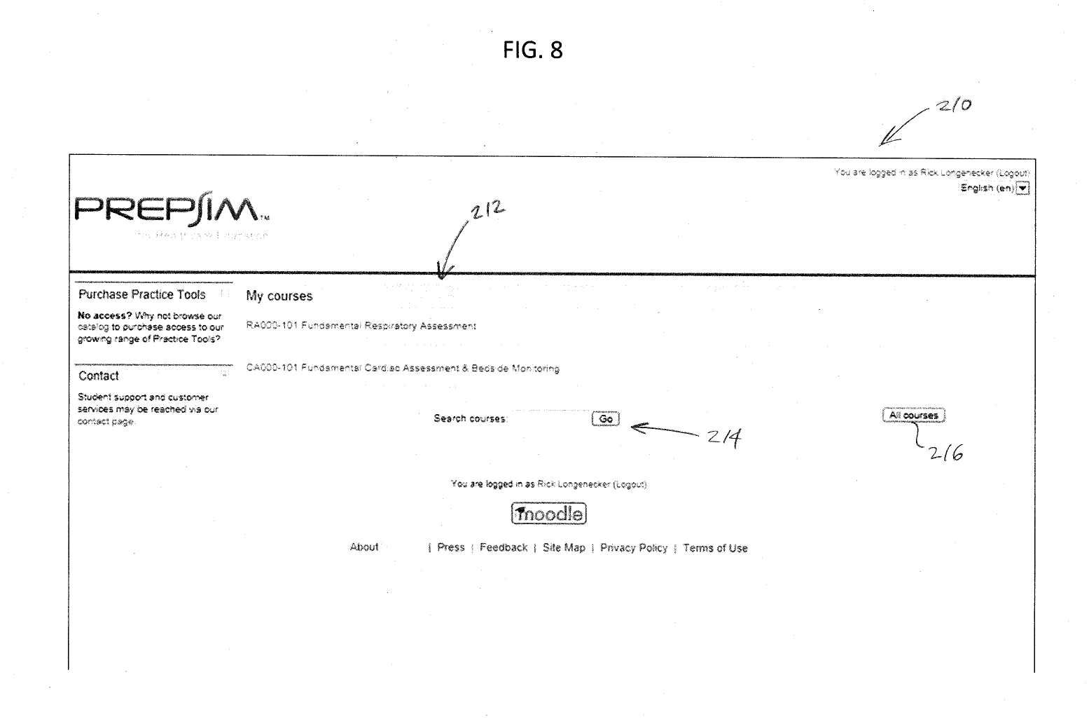

FIG. 8 is a screenshot showing a main course summary screen 210 generated by the system. Once the user has logged in, the user is provided with a list 212 that lists all of the “courses” to which the user has access. Access to any desired number of courses can be provided. For example, as shown in FIG. 8, the user has access to two courses: one course relating to fundamental respiratory assessment, and another course relating to fundamental cardiac assessment and bedside monitoring. Each course allows the student to practice medical/healthcare skills in an interactive environment generated by the system. A search field 214 is also provided for allowing the student to search for desired courses, and an “All Courses” button 216 allows the user to list all courses to which the user has access. On the left side of the screen 210, the user can also access functionality that allows the user to purchase additional courses, and to contact student and/or technical support.

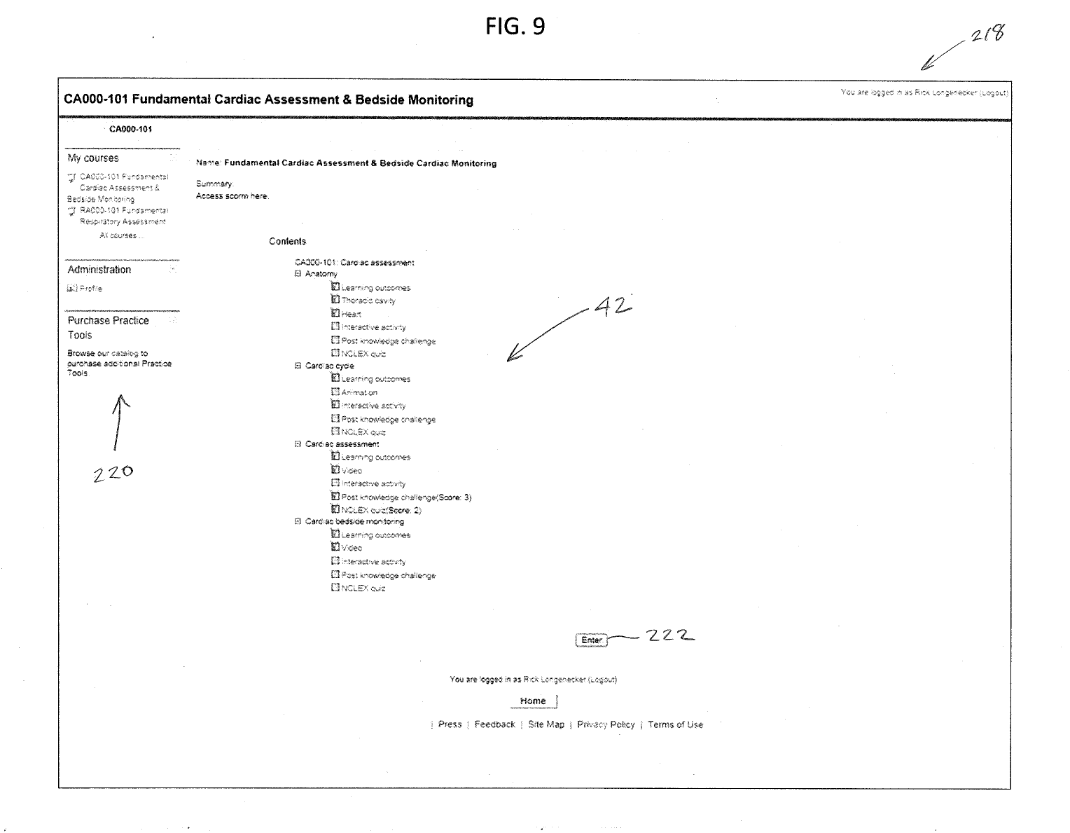

FIG. 9 is a screenshot showing an initial screen 218 generated by the system relating to a course selected by the user, i.e., a cardiac assessment and bedside cardiac practice course. The course is delivered to the user by way of one or more practice modules accessible as desired by the student, using the common practice tool directory structure 42 discussed in detail above in connection with FIGS. 1-2. Using the directory structure 42, the user can select a desire practice tool, and can click on the “Enter” button 222 to begin using the practice tool. Also provided in the screen 218 is a navigation bar 220 that allows the user to access other courses and perform other functions such as perform administrative functions and purchase additional practice tools.

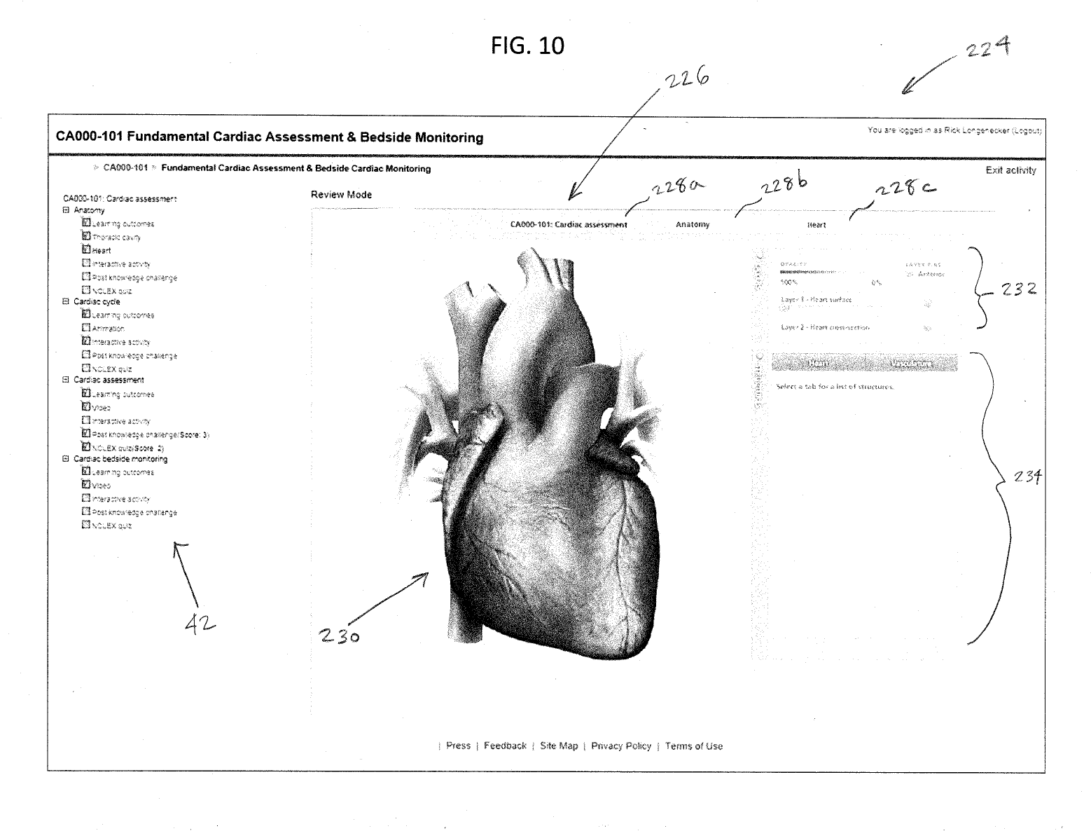

FIGS. 10-13 are screenshots showing a cardiac assessment and bedside cardiac practice module 224 in detail. Referring to FIG. 10, the module can be accessed by the user by clicking on the directory structure 42, which appears on the left-hand side of the screen. The screen includes a module navigation bar 226 that navigates the student through various phases or “chapters” of the practice module, e.g., cardiac assessment chapter 228a, cardiac cycle chapter 228b, heart chapter 228b, and other chapters of the practice module. Each chapter of the module could have rich, interactive, multimedia content. For example, as shown in FIG. 10, in the cardiac assessment chapter 228a, the user is provided with a rotatable, manipulable, three-dimensional model 230 of the human heart. Using layer controls 232, the user can selectively highlight different structures of the human heart, and can learn about such structures by way of dialog box 234. Thus, for example, if the student wishes to learn about vasculature of the heart, the user can adjust the transparency of the layers of the model 230 using the controls 232, so that only vasculature of the heart is highlighted in the model 230. Upon doing this, the dialog box 234 could be populated by the system with information relating to the vasculature of the human heart. Of course, the model 230 could be of other various parts of the human body.

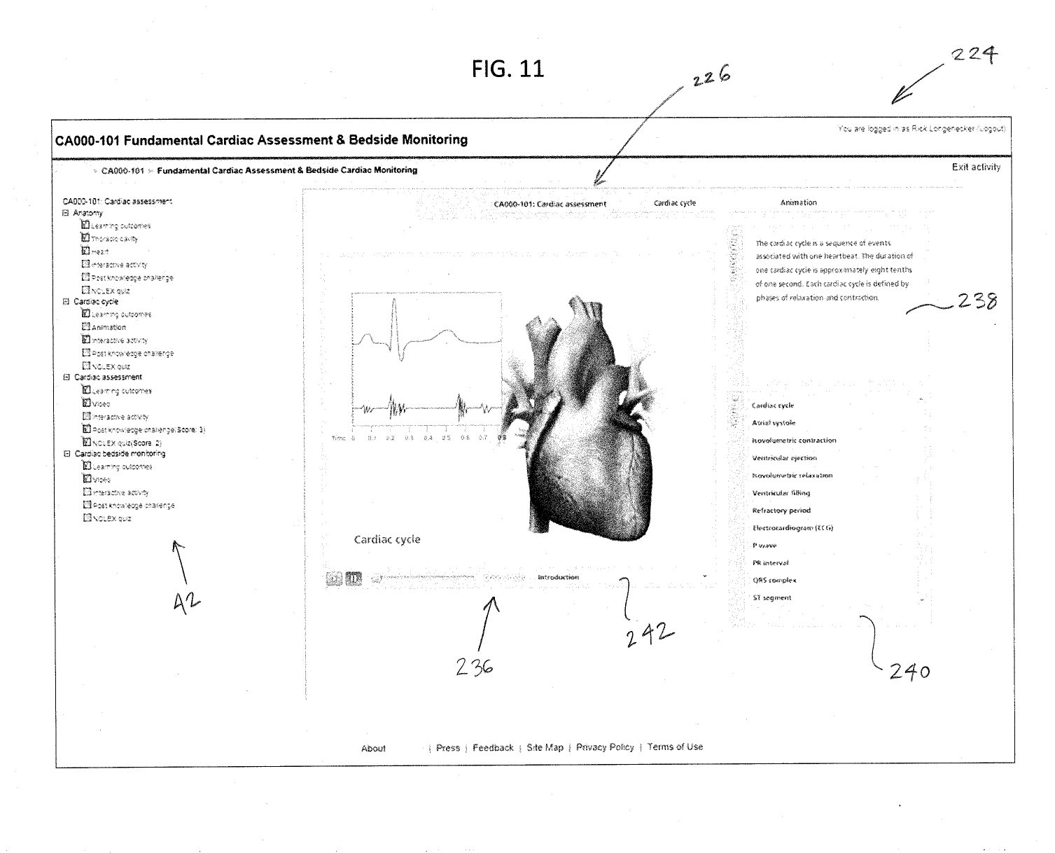

As shown in FIG. 11, a video clip 236 could be played to the user which illustrates a beating human heart as well as a simulated electrocardiogram corresponding to the beating heart. Sound of the beating heart could also be provided in conjunction with the video clip, as well as narration. The user can select desired portions of the video clip 236 to view by clicking on the topic pull-down list 242. The narration for the video clip 236 could also be presented to the user textually in a narration dialog box 238. Additionally, a list of terms could be provided to the user in 240, listing medical terms associated with the human heart. The user can click on the terms and be provided with a definition.

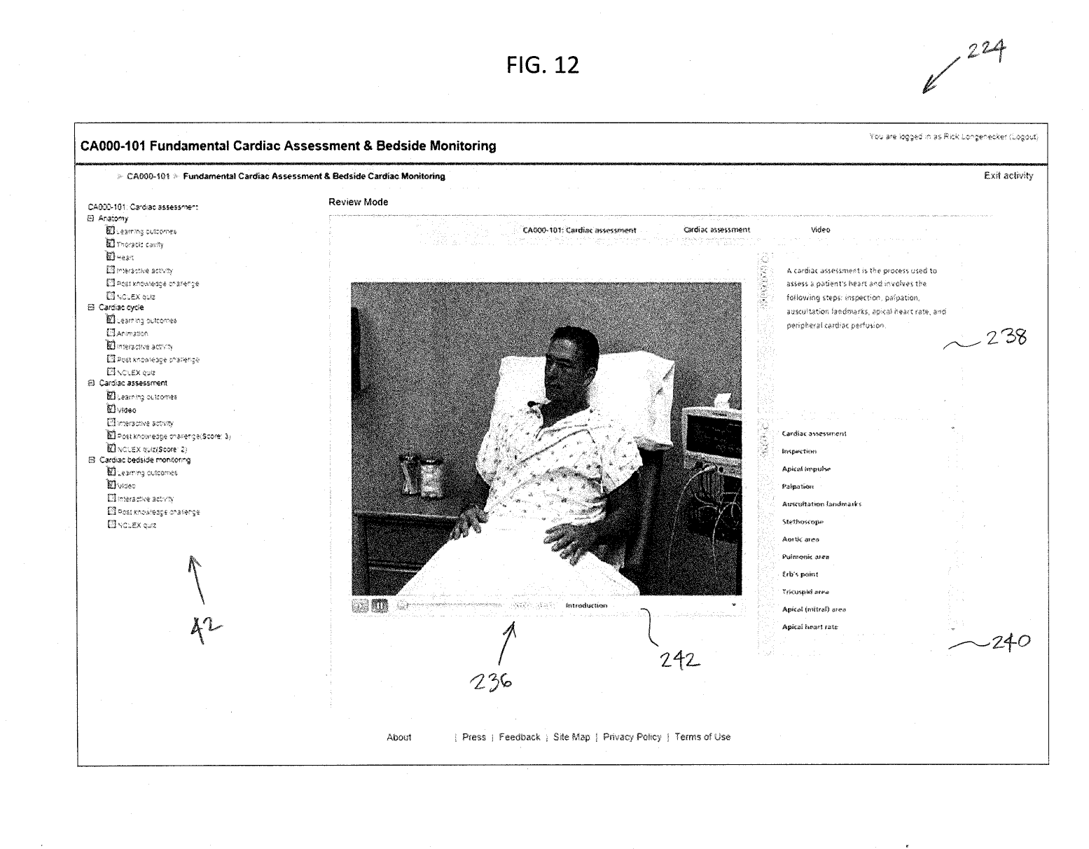

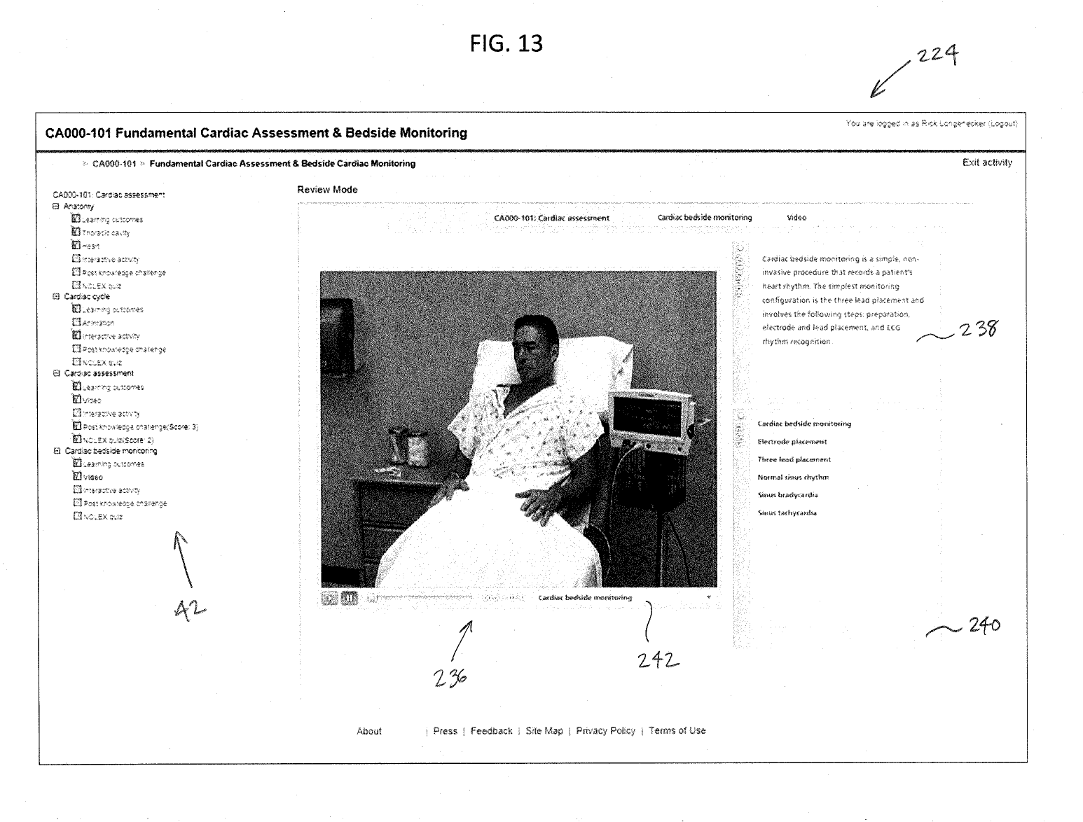

As shown in FIG. 12, the video clip 236 could also include an introductory portion that introduces the topic. Then, as shown in FIG. 13, the video clip 236 could illustrate skills relating to cardiac bedside monitoring. As can be seen, video clips of real patients could be used to convey the lesson, thereby heightening the realism and effectiveness of the lesson. As the video clip 236 is played, the contents of the narration dialog box 238 and the term list 240 are automatically updated to reflect information pertinent to the current portion of the video clip 236.

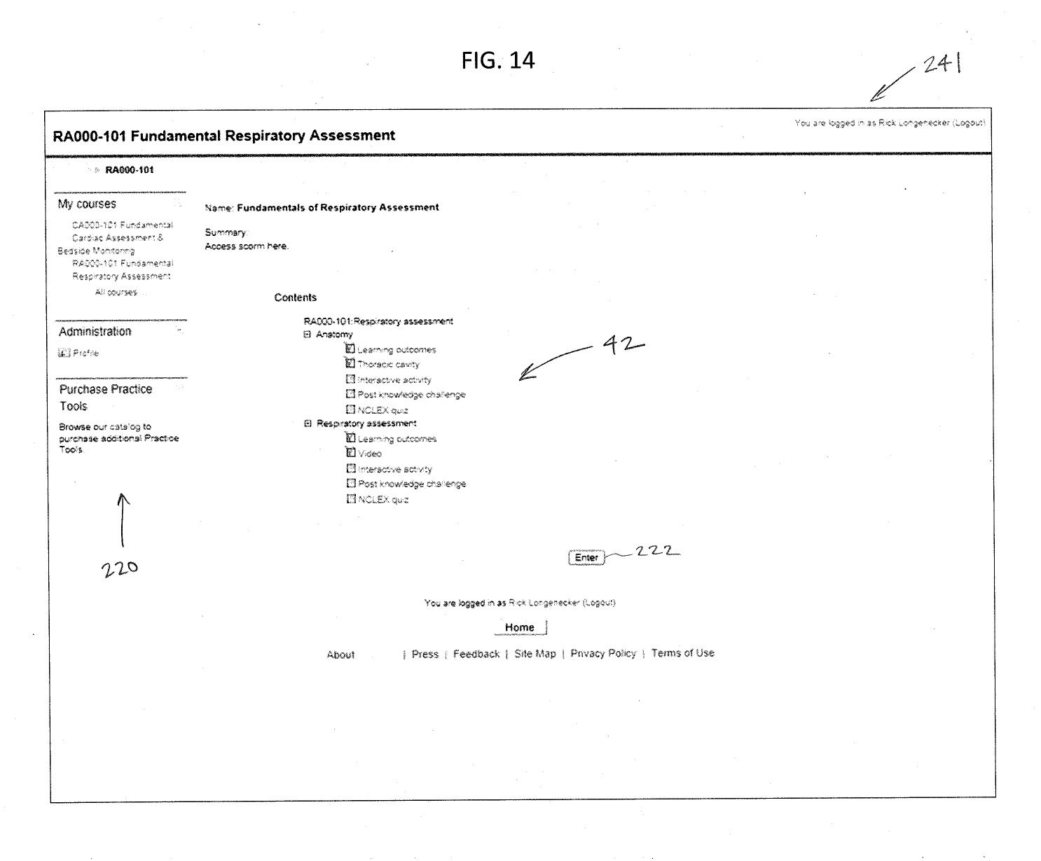

As can be appreciated, the subject matter of the course and associated practice tools/modules can be varied as desired. An example of another course and associated practice tools/modules offered by the present invention will now be discussed in connection with FIGS. 14-20.

FIG. 14 is a screenshot showing an initial screen 241 generated by the system, relating to a respiratory assessment practice course. As with the initial screen 218 discussed above, the initial screen 241 displays information about the course (in this case, respiratory assessment), and the common practice tool directory structure 42 is updated to reflect practice tools/modules that are available to the user and which relate to respiratory assessment. The navigation bar 220 discussed above is also provided. Upon selecting a desired practice module by clicking on the directory structure 42, the user can click the “Enter” button 222 to begin the module.

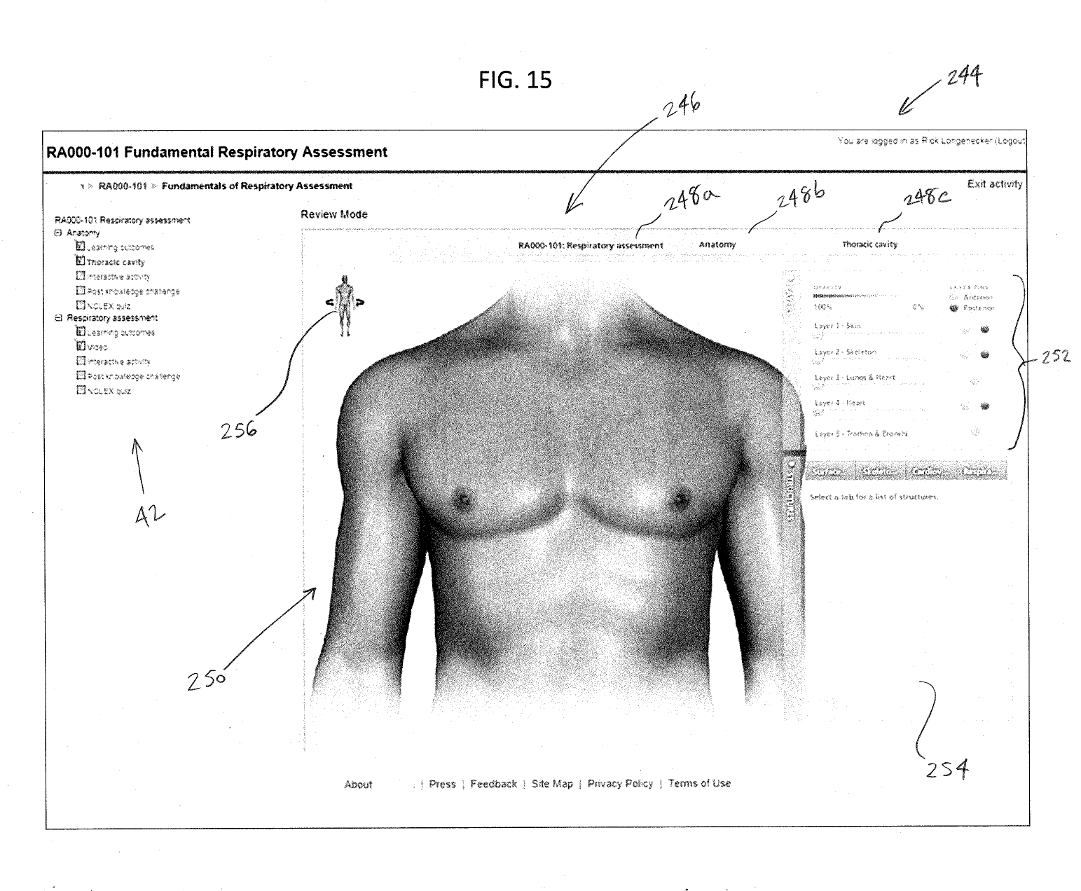

FIGS. 15-20 are screenshots showing the respiratory assessment practice module 244 in detail. Referring to FIG. 15, the module can be accessed by the user by clicking on the directory structure 42, which appears on the left-hand side of the screen. The screen includes a module navigation bar 246 that navigates the student through various phases or “chapters” of the practice module, e.g., respiratory assessment chapter 248a, anatomy chapter 248b, thoracic chapter 248c, and other chapters of the practice module. Each chapter of the module could have rich, interactive, multimedia content. For example, as shown in FIG. 15, in the respiratory assessment chapter 248a, the user is provided with a rotatable, manipulable, three-dimensional model 250 of the human body. The model 250 can be rotated by the user using rotation control 256. Using layer controls 252, the user can selectively highlight different structures of the body, and can learn about such structures by way of dialog box 254. Thus, for example, if the student wishes to learn about skeletal structure of the human body, the user can adjust the transparency of the layers of the model 250 using the controls 252, so that only skeletal structure of the body are highlighted in the model 250. Upon doing this, the dialog box 254 could be populated by the system with information relating to the skeletal structures of the human body. Of course, the model 250 could show other parts of the human body.

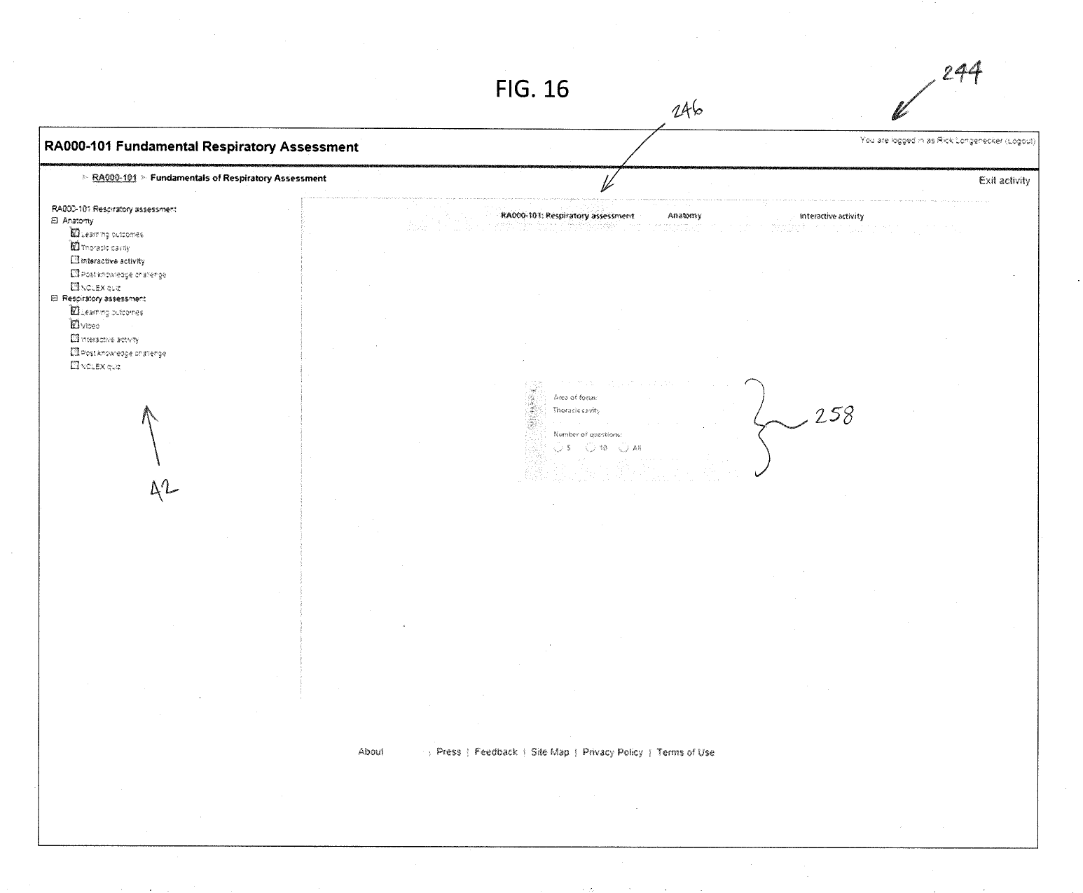

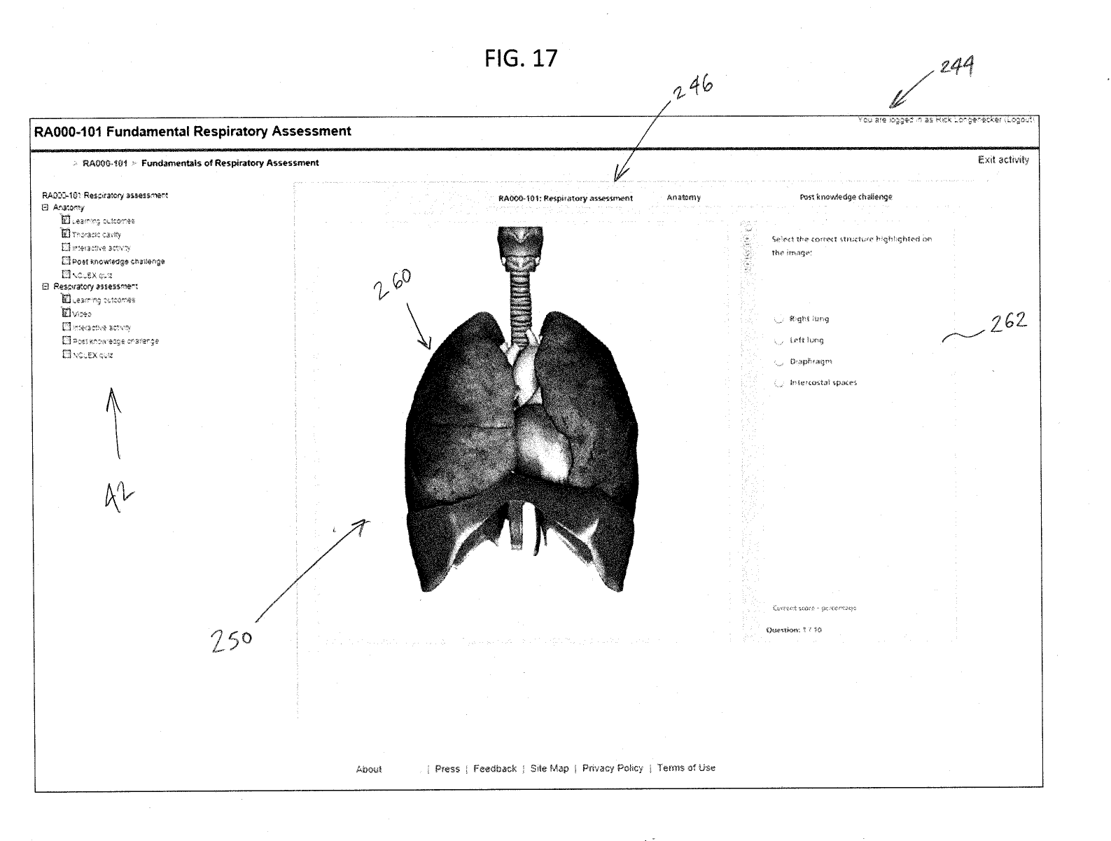

As shown in FIG. 16, the user can adjust the model 250 to focus on specific parts of the human body, using controls 258. For example, as shown in FIG. 16, the user can choose to focus on the thoracic cavity using the controls 258, and can also specify a desired number questions to be asked during the lesson. The results of this selection are shown in FIG. 17, wherein the model 250 is updated to show only thoracic structures 260 of the human body. The model 250 is thus dynamic and can be easily changed by the user to focus on specific subject matter. A dialog panel 262 is provided, wherein the user is asked questions by the system relating to the structures 260 shown in the model 250, so as to enhance learning. For example, the system can automatically highlight a specific structure 260 (such as the left lung, by coloring the structure blue), and a question can be presented in the dialog panel 262 which specifically relates to the highlighted structure. The student can answer the question by clicking on a radio button in the dialog panel 262, and the system can identify whether the answer is correct or incorrect. Additionally, the user's current score can be tracked and displayed, as shown at the bottom of dialog panel 262. As can be appreciated, the system facilitates rich, interactive learning for the student, using the various interactive components disclosed herein.

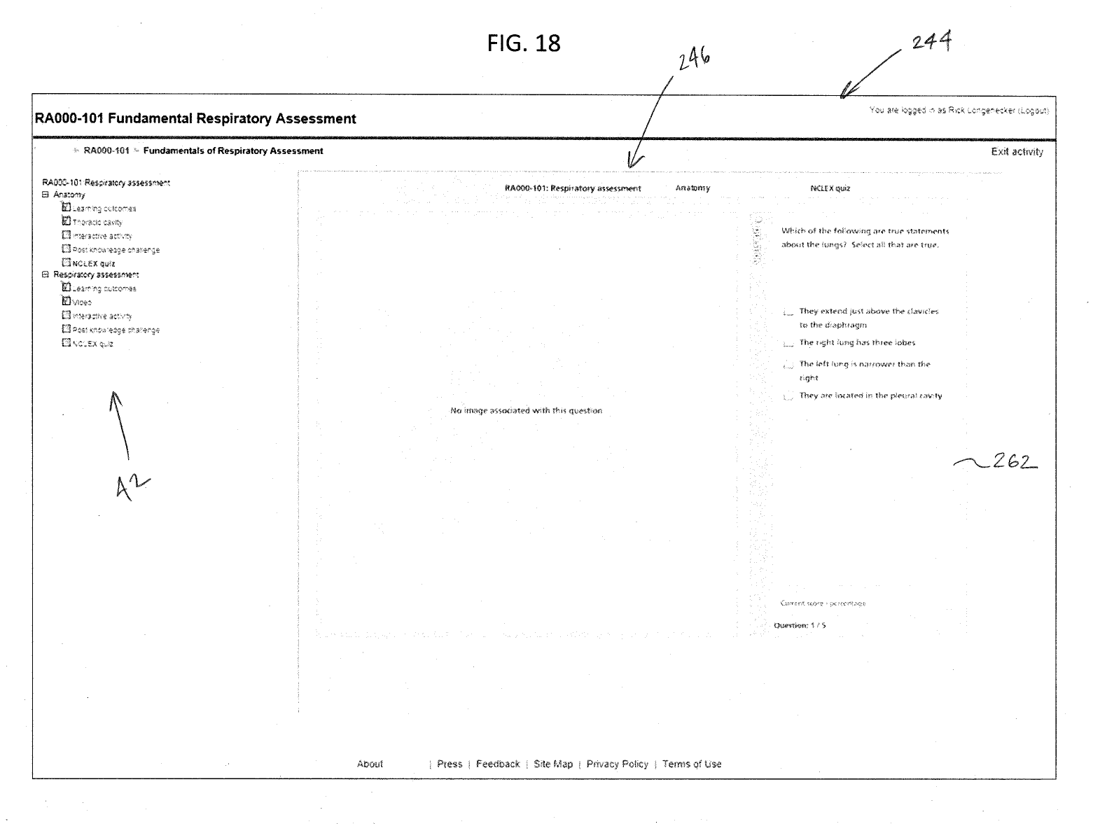

As shown in FIG. 18, questions presented to the user in the dialog box 262 need not be associated with a three-dimensional model. Indeed, as shown, the dialog box 262 could ask the student to select a correct statement from a list of statements, e.g., relating to the lungs of the human body.

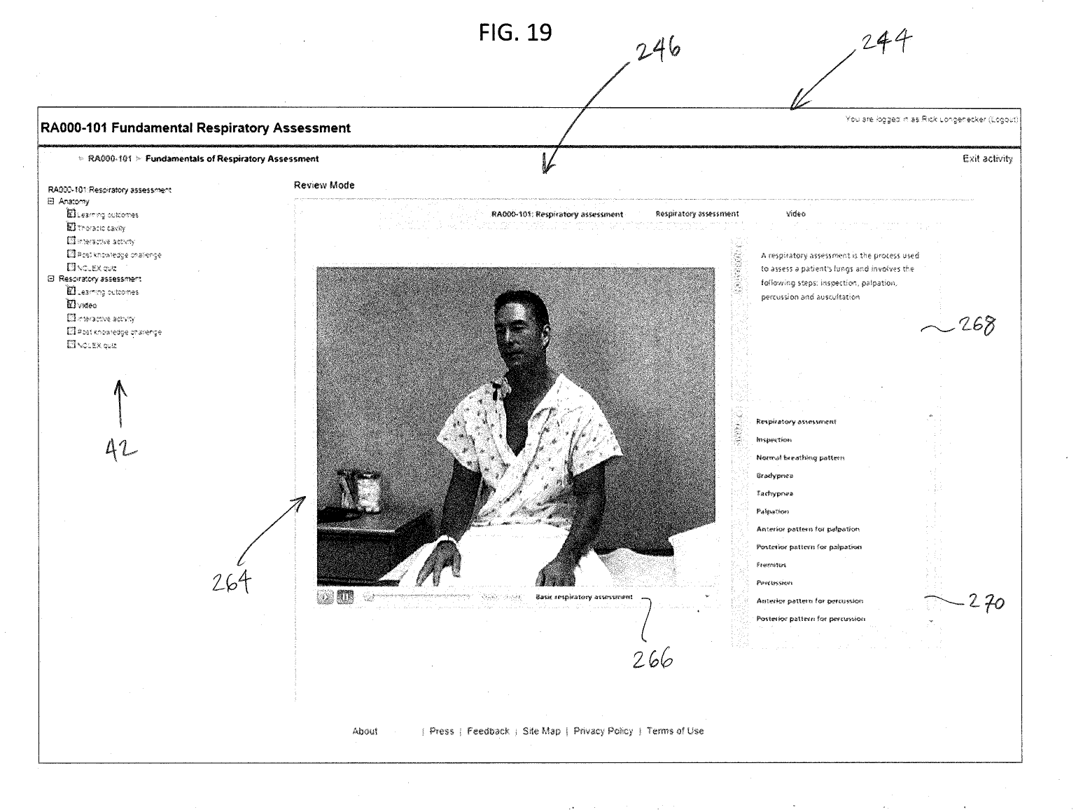

As shown in FIG. 19, a video clip 264 could be played to the user, which illustrates desired skills such as respiratory assessment skills on a real patient. The user can select desired portions of the video clip 264 to view by clicking on the topic pull-down list 266. The narration for the video clip 264 could also be presented to the user textually in a narration dialog box 268. Additionally, a list of terms could be provided to the user in list 270, listing medical terms associated with the respiratory diagnosis/assessment. The user can click on the terms and be provided with a definition.

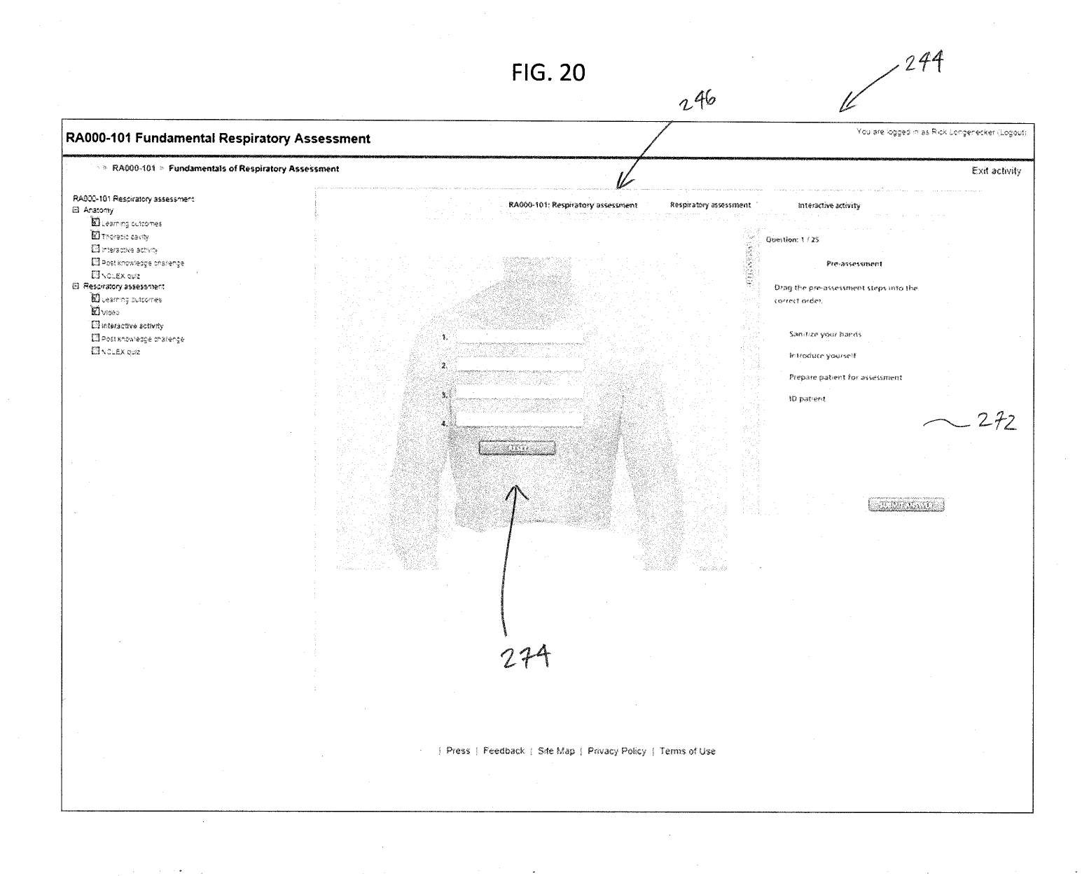

As shown in FIG. 20, the user could be provided with an interactive quiz or test 274 that assesses the student's knowledge. As shown, the quiz 274 could be conveyed in the form of interactive screens that are displayed to the user, and which are periodically paused so that questions can be asked of the student. For example, as shown in FIG. 20, a question could be presented asking the student to identify a correct sequence of pre-assessment steps in connection with examining a patient. To answer the question, the user can click and drag the answers appearing in an assessment dialog box 272, and drop the answers into the quiz 274. The user can reset his/her answer before submitting the answer (e.g., the user can re-order the proposed answers). Of course, other forms of tests/quizzes are possible.

As can be appreciated by the foregoing discussion in connection with FIGS. 4-21, the system of the present invention provides a rich, interactive, online practice environment that students can use to enhance learning of medical/healthcare-related subjects, and importantly, to gain valuable experience practicing learned skills. Advantageously, the courses and associated practice tools/modules can be accessed on demand by the student, and can be repeated often and as frequently as desired by the student to reinforce learning.

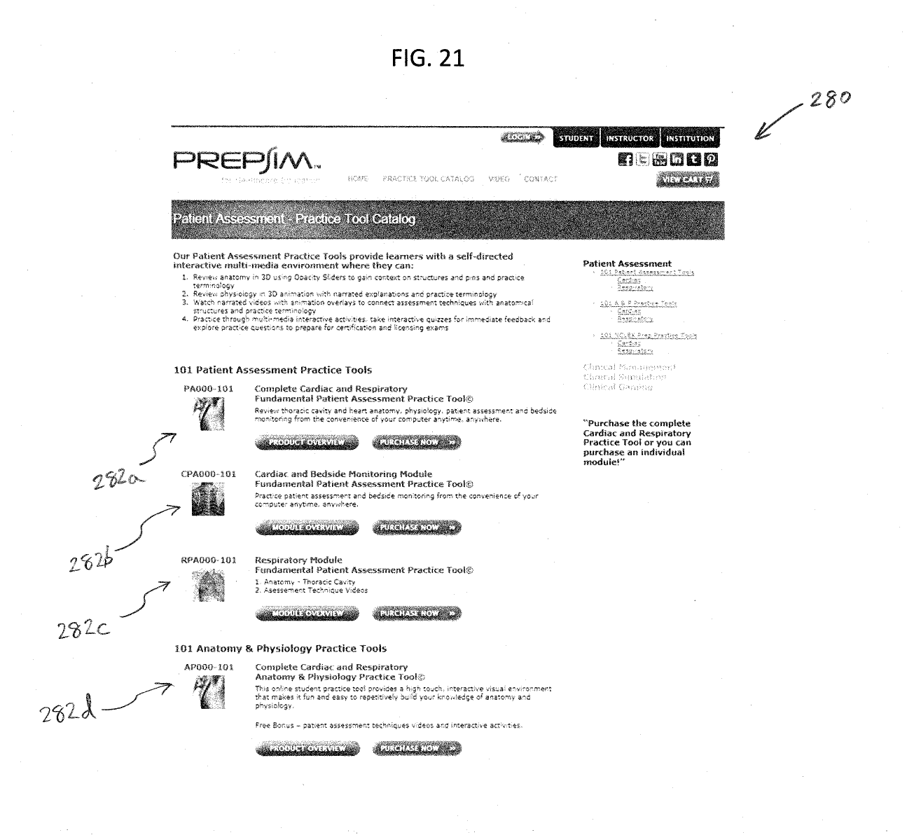

FIG. 21 is a screenshot showing a catalog screen 280 generated by the system relating to a patient assessment practice tool catalog. As can be seen, the system allows the user to browse through a catalog of numerous practice modules 282a-282d that can be provided by the system. An overview of each module can be accessed via the catalog, and desired modules can be purchased.

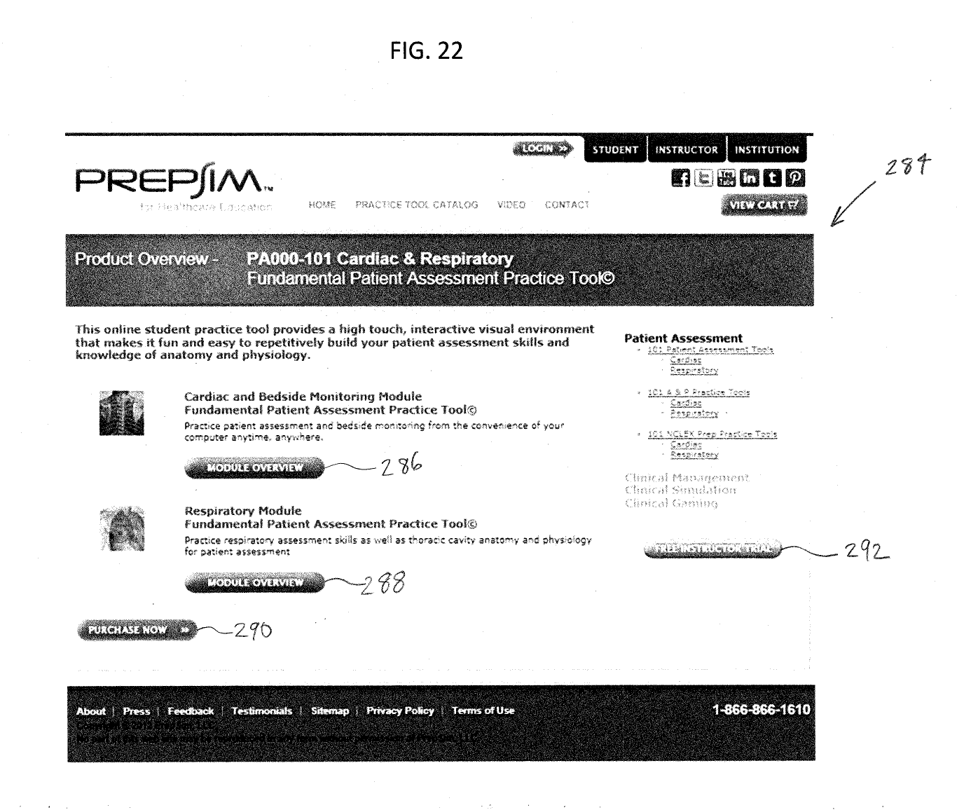

FIG. 22 is a screenshot showing a product overview screen 284 generated by the system relating to a cardiac and respiratory practice module. The product overview screen 284 provides more detailed information to the user about a specific module, and includes buttons 286-288 that can be clicked by the user to access more detailed overviews, as well as a “Purchase Now” button 290 that allows the user to purchase desired modules. Moreover, a “Free Instructor Trial” button 292 is provided, which allows an instructor to request a free trial of a particular module.

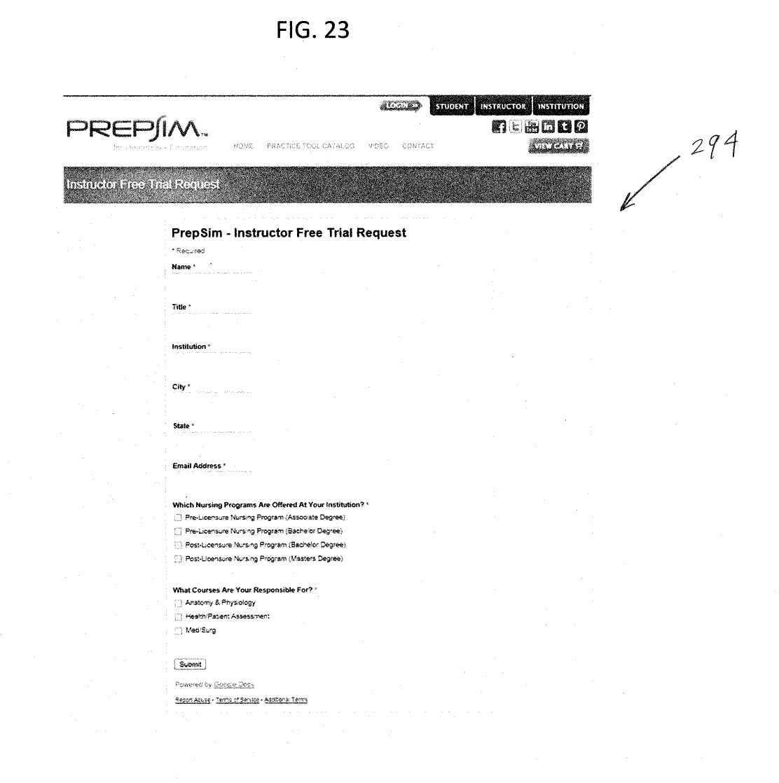

FIG. 23 is a screenshot showing a screen 294 generated by the system for allowing an instructor to request a free trial of a desired practice module. The screen request the instructor to provide contact information, as well as information relating to programs offered at the instructor's institution and course for which the instructor is responsible. Once the information is submitted, access to a free trial version of a practice module is provided to the instructor.

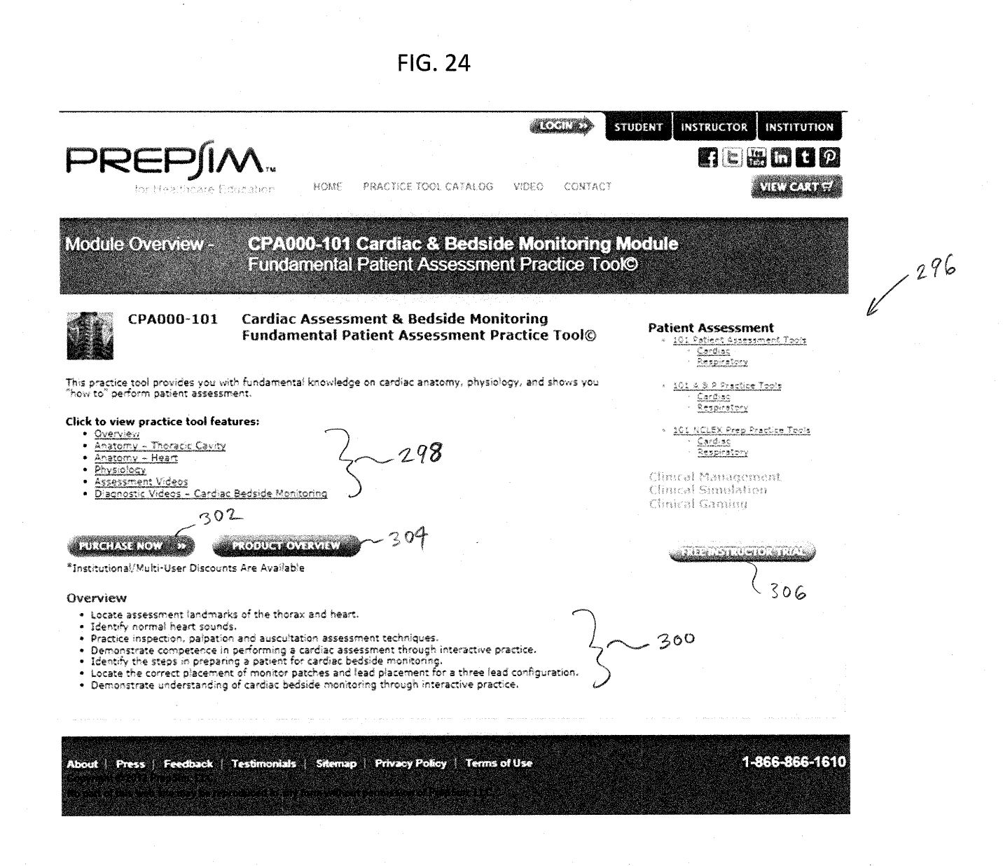

FIG. 24 is a screenshot showing a module overview screen 296 generated by the system relating to a cardiac and bedside monitoring module. As with the overview screen discussed above in FIG. 22, the overview screen 296 provides detailed information about a specific module, and includes hyperlinks 298 to specific overview sections as well as summary bullet points 300 highlighting important features of the module. The module can be purchased by clicking the “Purchase Now” button 302, and a more detailed overview can be accessed by clicking the “Product Overview” button 304. Additionally, a free instructor trial can be requested by clicking the “Free Instructor Trial” button 306.

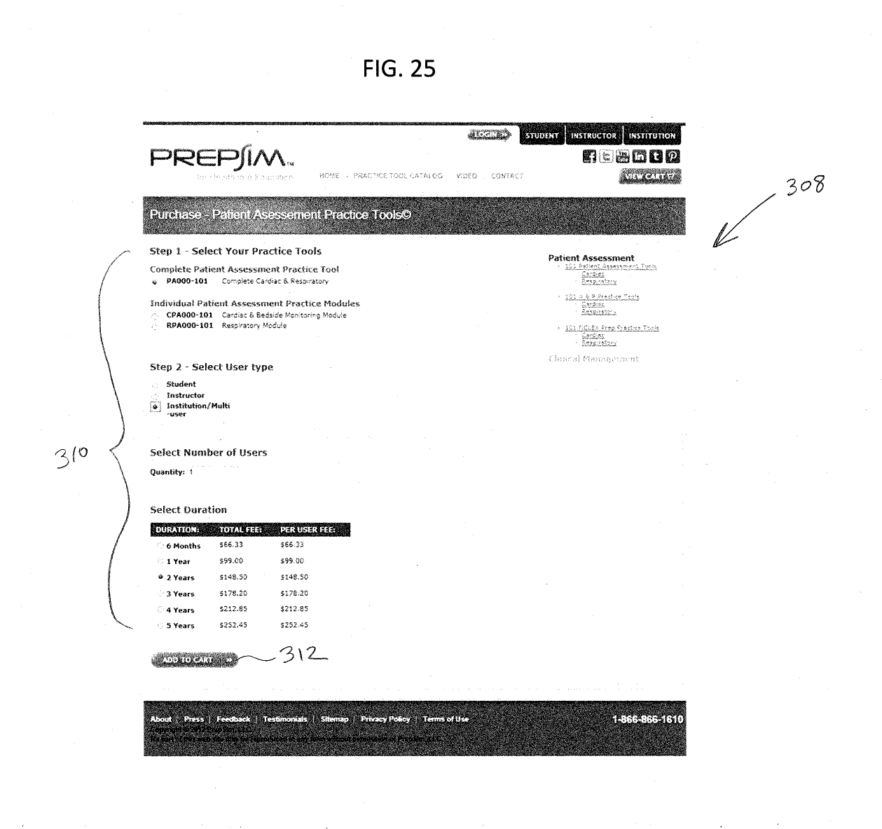

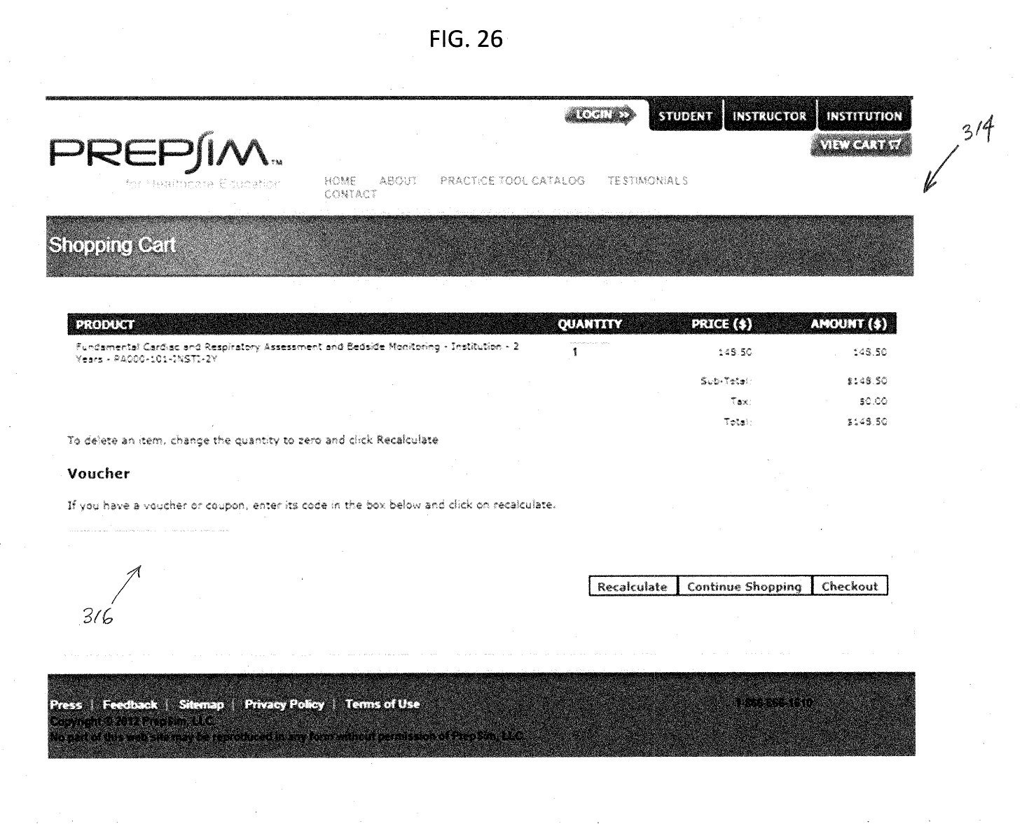

FIGS. 25-31 are screenshots showing various screens generated by the system for allowing a user to purchase one or more practice modules. As shown in FIG. 25, a first purchase screen 308 is provided, wherein the user selects one or more desired practice module to be purchased using controls 310. The user can specify the desired number of users for the module to be purchased, as well as one or more subscription durations for the module. The module can then be added to the user's virtual “shopping cart” by clicking the “Add to Cart” button 312. As shown in FIG. 26, the system displays a shopping cart summary screen 314 that lists the products currently selected by the user for purchase. A voucher or coupon can be redeemed using the field 316.

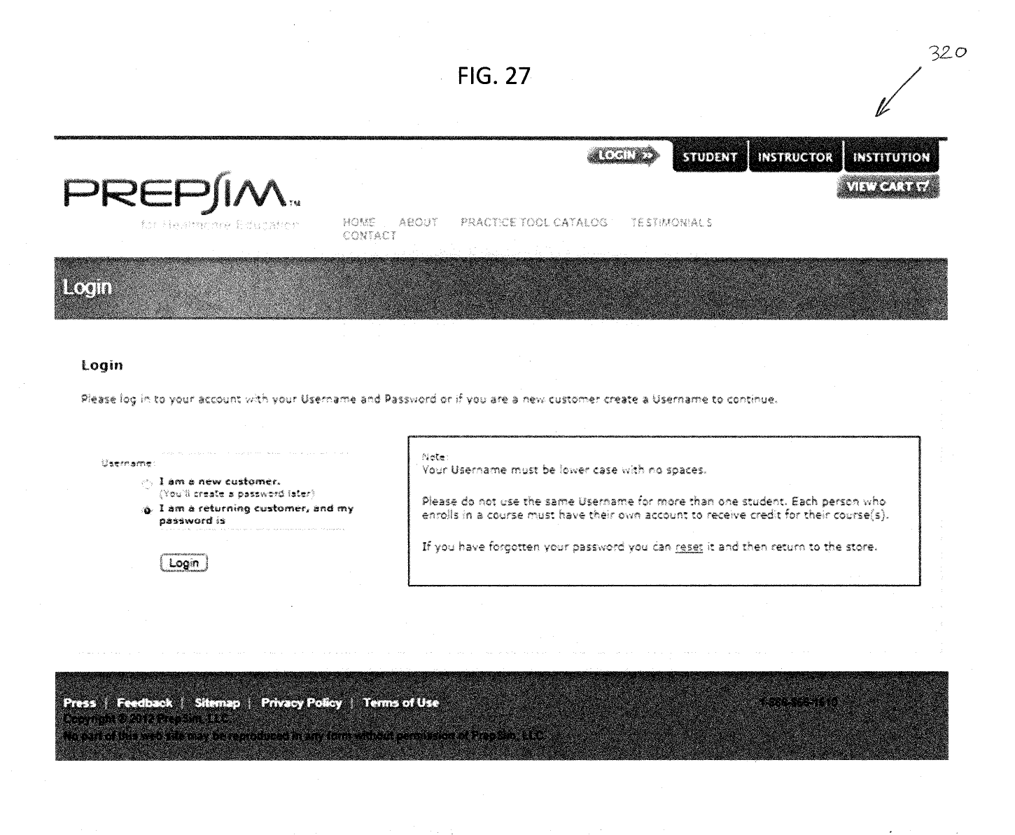

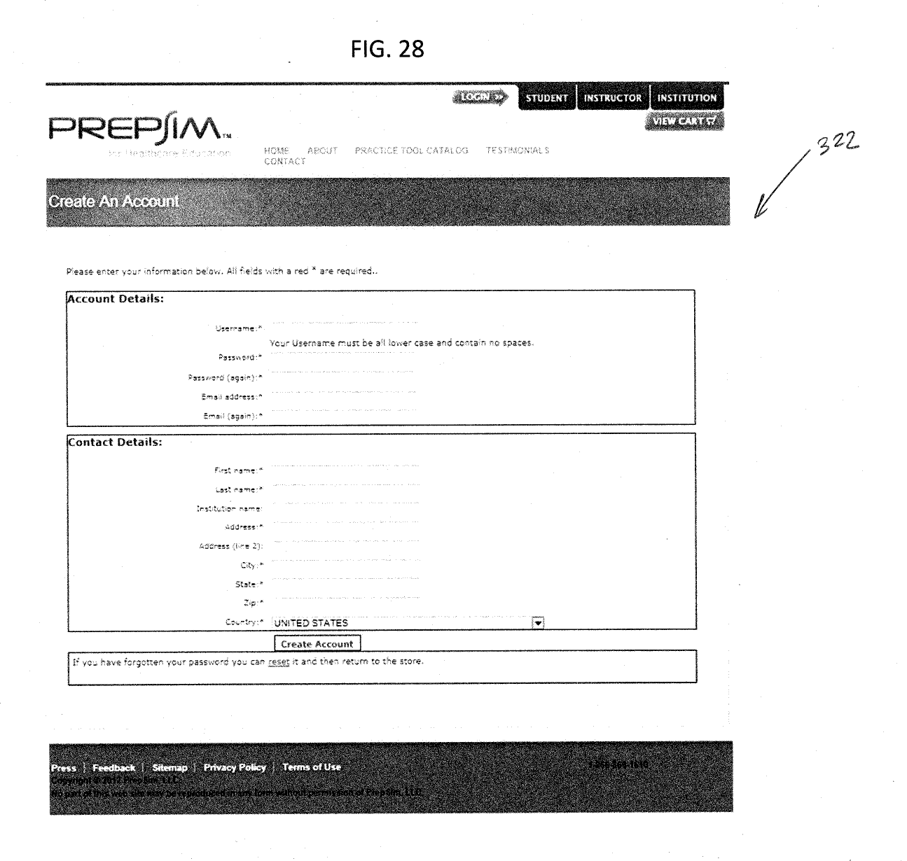

As shown in FIG. 27, before module(s) can be purchased, the user must be registered using login screen 320. As shown in FIG. 28, if the user does not have an existing account, the user can open an account using the screen 322 (which requests information from the user about account details and contact information).

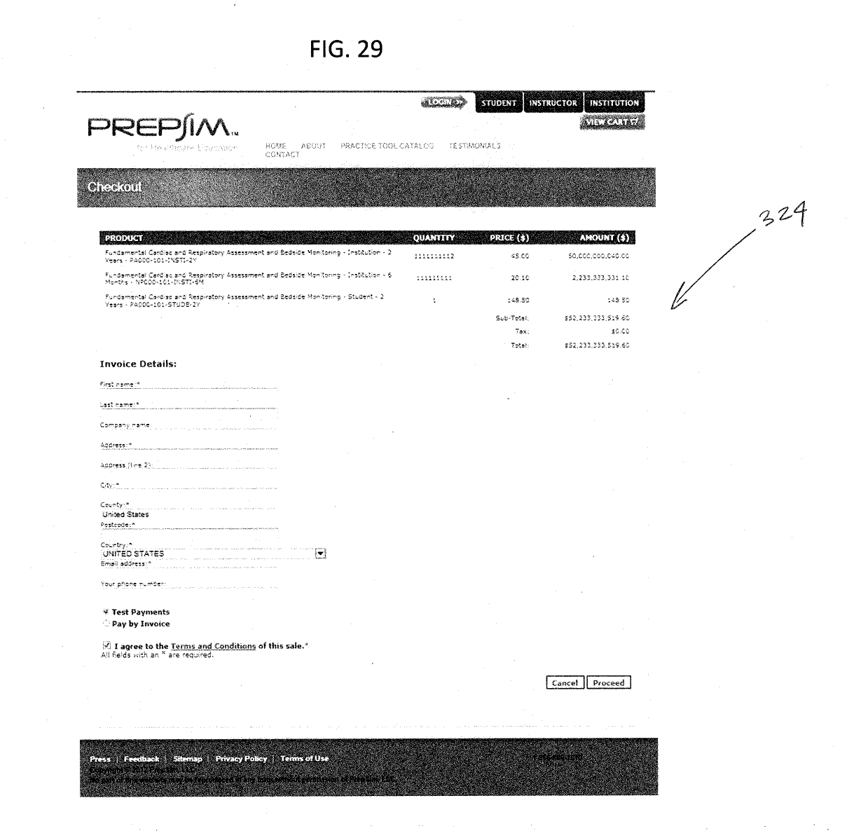

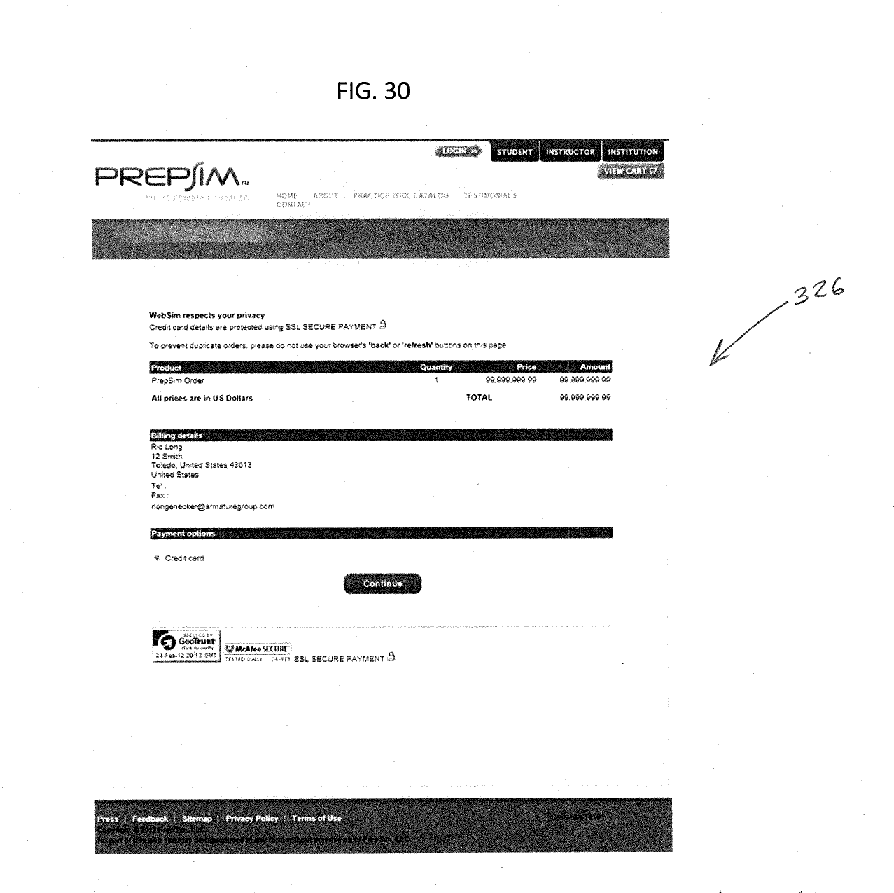

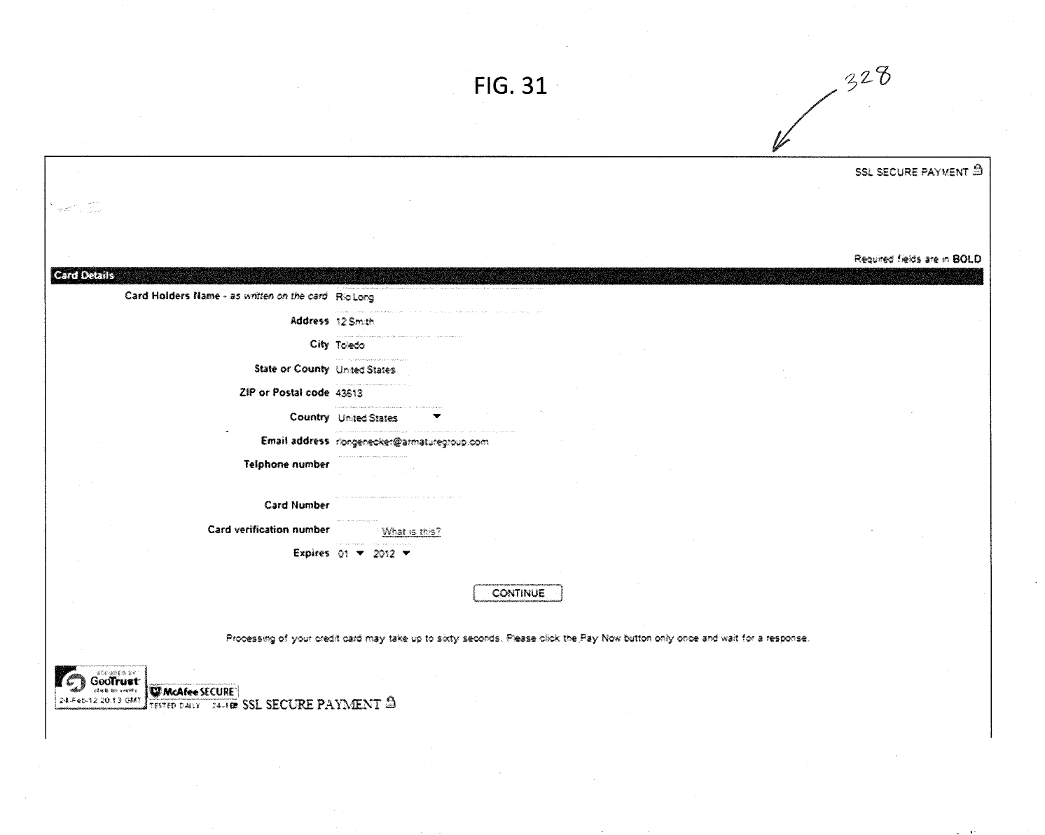

As shown in FIG. 29, after all desired module(s) have been selected for purchase, the user provides invoice detail information using the invoice screen 324. Then, as shown in FIGS. 30-31, the user can pay for the modules using payment screen 326, 328 (which, for example, allow for payment by credit card). Upon successful processing by the system of the payment, access to the purchased module(s) is granted to the user by the system.

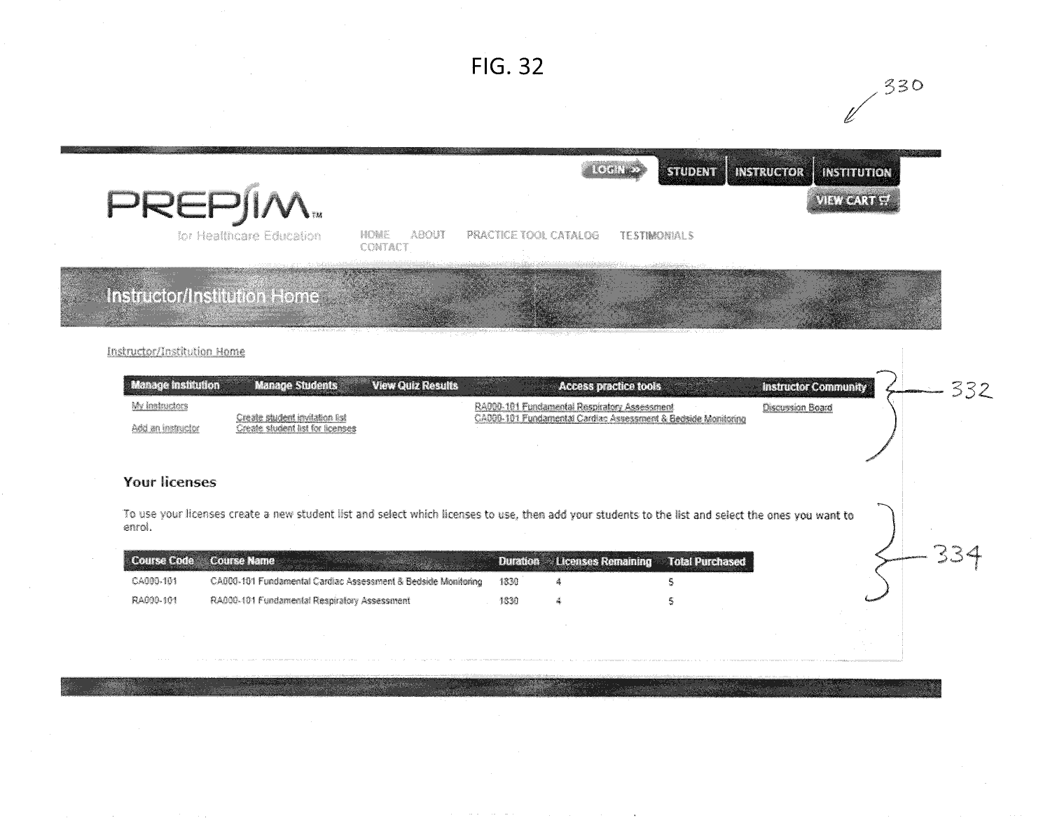

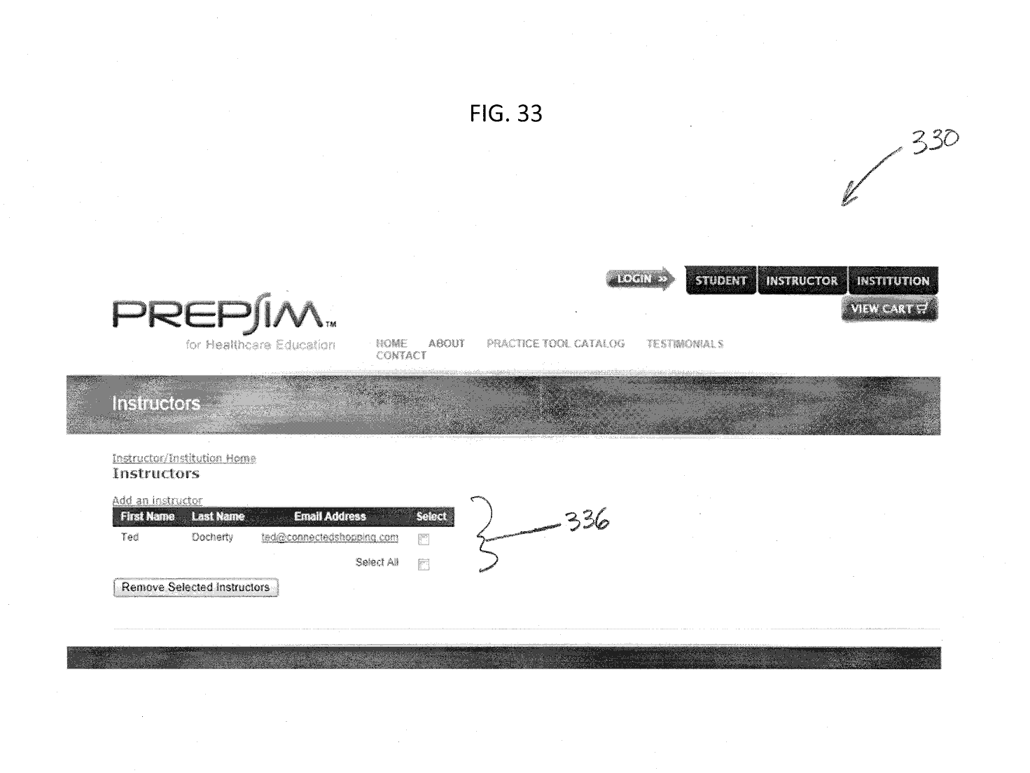

FIGS. 32-33 are screenshots illustrating a “dashboard” 330 generated by the system for allowing an instructor or an institutional user to monitor/control account settings and parameters and to perform other functions. As can be seen in FIG. 32, the dashboard allows an instructor or an institutional user to perform various functions 332, such as manage institution attributes, manage students, access practice tools, start or access a discussion board, create a student invitation list, create a student list for one or more licensees, add or remove instructors, etc. Moreover, the dashboard 330 allows licensees to create/modify student lists and administer courses, using controls 334. As shown in FIG. 33, the dashboard 330 allows instructors to be added or removed using controls 336, as well as to update instructor contact information.

Having thus described the invention in detail, it is to be understood that the foregoing description is not intended to limit the spirit or scope thereof. What is desired to be protected is set forth in the following claims.

What is claimed is:

1. An online, interactive practice system comprising:
a computer system in communication with a plurality of remote user devices via a network;
a plurality of multimedia practice modules stored in a database of the computer system, each of the plurality of multimedia practice modules including a lesson relating to a healthcare-related topic and allowing a user to practice a skill relating to the lesson; and
a common directory structure for aggregating each of the plurality of multimedia practice modules and allowing a user to select one of the plurality of multimedia practice modules, the common directory structure accessible using one or more of the plurality of remote user devices,
wherein, in response to selection of one of the plurality of multimedia practice modules from the common directory structure, the computer systems transmits a software module corresponding to a selected multimedia practice module to at least one of the plurality of remote user devices, and the at least one of the plurality of remote user devices executes the transmitted software module to generate a virtual practice environment at the remote user device where the user can view a healthcare-related lesson and virtually practice a healthcare-related skill relating to the healthcare-related lesson.

2. The system of claim 1, wherein the virtual practice environment includes a three-dimensional model of a human body or an organ.

3. The system of claim 2, wherein the three-dimensional model is rotatable by the user.

4. The system of claim 2, wherein the virtual practice environment includes a narration relating to the healthcare topic, the narration corresponding to one or more features in the model of the human body or the organ.

5. The system of claim 2, wherein the virtual practice environment highlights a specific structure in the model of the human body or the organ and presents a question to the user relating to the highlighted structure.

6. The system of claim 2, wherein the virtual practice environment includes a plurality of controls for controlling one or more display layers of the model.

7. The system of claim 1, wherein the virtual practice environment plays an audio clip containing a narration relating to the lesson.

8. The system of claim 1, wherein the virtual practice environment plays a video clip relating to the lesson.

9. The system of claim 1, wherein the virtual practice environment generates a test or a quiz relating to the lesson.

10. The system of claim 1, further comprising a second computer system in communication with the first computer system, the second computer system processing orders for one or more of the plurality of practice modules and handling payment for the orders.

11. The system of claim 1, further comprising a dashboard generated by the computer system for allowing an instructor or an administrator to manage one or more user accounts.

12. The system of claim 1, wherein the plurality of practice modules comprise at least one of an anatomy practice module, a physiology practice module, a patient assessment practice module, a clinical manifestation practice module, a diagnostic testing module, a diagnosis module, an intervention module, an outcomes module, a case management module, or a clinical decision making module.

13. The system of claim 12, wherein each of the plurality of practice modules further comprises a sub-module including at least one of a learning outcomes sub-module, an animation sub-module, an interactive activity, a quiz, a test, or a certification or licensing examination.

14. An online, interactive practice system comprising:
a computer system in communication with a plurality of remote user devices via a network;
a plurality of multimedia practice modules stored in a database of the computer system, each of the plurality of multimedia practice modules including a lesson relating to a professional or vocation-related topic and allowing a user to practice a skill relating to the lesson; and
a common directory structure for aggregating each of the plurality of multimedia practice modules and allowing a user to select one of the plurality of multimedia practice modules, the common directory structure accessible using one or more of the plurality of remote user devices,
wherein, in response to selection of one of the plurality of multimedia practice modules from the common directory structure, the computer systems transmits a software module corresponding to a selected multimedia practice module to at least one of the plurality of remote user devices, and the at least one of the plurality of remote user devices executes the transmitted software module to generate a virtual practice environment at the remote user device where the user can view a professional or vocation-related lesson and virtually practice a skill relating to the profession or vocation-related lesson.

15. The system of claim 14, wherein the virtual practice environment includes a narration relating to the lesson.

16. The system of claim 14, wherein the virtual practice environment plays an audio clip containing a narration relating to the lesson.

17. The system of claim 14, wherein the virtual practice environment plays a video clip relating to the lesson.

18. The system of claim 14, wherein the virtual practice environment generates a test or a quiz relating to the lesson.

19. The system of claim 14, wherein the virtual practice environment generates a three-dimensional model relating to the lesson.

20. A method for online, interactive practice, comprising the steps of:
providing a computer system in communication with a plurality of remote user devices via a network;
storing a plurality of multimedia practice modules stored in a database of the computer system, each of the plurality of multimedia practice modules including a lesson relating to a healthcare-related topic and allowing a user to practice a skill relating to the lesson;
aggregating each of the plurality of multimedia practice modules using a common directory structure;
allowing a user to select one of the plurality of multimedia practice modules by accessing the directory structure using one or more of the plurality of remote user devices;
transmitting a software module corresponding to a selected multimedia practice module to at least one of the plurality of remote user devices from the computer system;
executing the transmitted software module to generate a virtual practice environment at the remote user device;
presenting a healthcare-related lesson to the user using the virtual practice environment; and
allowing a user to virtually practice a healthcare-related skill relating to the healthcare-related lesson, using the virtual practice environment.

21. The method of claim 20, further comprising displaying in the virtual practice environment a three-dimensional model of a human body or an organ.

22. The method of claim 21, further comprising allowing a user to rotate the three-dimensional model.

23. The method of claim 20, further comprising generating a narration relating to the healthcare topic, the narration corresponding to one or more features in the model of the human body or the organ.

24. The method of claim 20, further comprising highlighting a specific structure in the model of the human body or the organ and presenting a question to the user relating to the highlighted structure.

25. The method of claim 20, further comprising allowing a user to control one or more display layers of the model.

26. The method of claim 20, further comprising playing an audio clip in the virtual practice environment containing a narration relating to the lesson.

27. The method of claim 20, further comprising playing a video clip in the virtual practice environment relating to the lesson.

28. The method of claim 20, further comprising generating a test or a quiz in the virtual practice environment relating to the lesson.

29. A method for online, interactive practice, comprising the steps of:
providing a computer system in communication with a plurality of remote user devices via a network;
storing a plurality of multimedia practice modules stored in a database of the computer system, each of the plurality of multimedia practice modules including a lesson relating to a professional or vocation-related topic and allowing a user to practice a skill relating to the lesson;
aggregating each of the plurality of multimedia practice modules using a common directory structure;
allowing a user to select one of the plurality of multimedia practice modules by accessing the directory structure using one or more of the plurality of remote user devices;
transmitting a software module corresponding to a selected multimedia practice module to at least one of the plurality of remote user devices from the computer system;
executing the transmitted software module to generate a virtual practice environment at the remote user device;
presenting a healthcare-related lesson to the user using the virtual practice environment; and
allowing a user to virtually practice a professional or vocation-related skill relating to the lesson, using the virtual practice environment.

30. The method of claim 29, further comprising generating a narration relating to the professional or vocation-related topic.

31. The method of claim 29, further comprising playing an audio clip in the virtual practice environment containing a narration relating to the lesson.

32. The method of claim 29, further comprising playing a video clip in the virtual practice environment relating to the lesson.

33. The method of claim 29, further comprising generating a test or a quiz in the virtual practice environment relating to the lesson.
